(19) United States
(12) Patent Application Publication
(10) Pub. No.: US 2014/0377551 A1
(43) Pub. Date: Dec. 25, 2014

(54) PRESSURE-SENSITIVE ADHESIVE COMPOSITION, SURFACE PROTECTIVE FILM, AND OPTICAL MEMBER

(71) Applicant: NITTO DENKO CORPORATION, Osaka (JP)

(72) Inventors: Kenichi KATAOKA, Osaka (JP); Tatsumi AMANO, Osaka (JP)

(73) Assignee: NITTO DENKO CORPORATION, Osaka (JP)

(21) Appl. No.: 14/310,441

(22) Filed: Jun. 20, 2014

(30) Foreign Application Priority Data
Jun. 25, 2013 (JP) 2013-132943
Apr. 18, 2014 (JP) 2014-086086

(51) Int. Cl. C09J 133/08; H01B 1/22

(52) U.S. Cl. CPC C09J 133/08; H01B 1/22; C09J 2433/00
USPC 428/354; 428/355 AC; 428/356; 252/519.21

(57) ABSTRACT

Provided is a pressure-sensitive adhesive composition for acrylic film protection which can forma surface protective film (pressure-sensitive adhesive sheet) excellent in antistatic properties, adherability, removability and workability for acrylic films (acrylic resins) and usable for acrylic film protection. The pressure-sensitive adhesive composition for acrylic film protection of the invention contains a (meth)acrylic polymer containing a (meth)acrylic monomer having an alkyl group of 1 to 14 carbon atoms in a proportion of 50 to 99.9 wt % as a monomer component, a tri-functional isocyanate crosslinking agent, a di-functional isocyanate crosslinking agent, an organopolysiloxane having oxyalkylene chains, and an ionic compound.

### BACKGROUND OF THE INVENTION

1. Field of the Invention

The present invention relates to a pressure-sensitive adhesive composition, a surface protective film, and an optical member.

A pressure-sensitive adhesive composition for acrylic film protection according to the present invention is useful as a surface protective film for acrylic film protection to be used for the purpose of protecting the surface of an acrylic film in the case where the surface of an optical member such as a polarizing plate, a wavelength plate, a retardation plate, an optical compensation film, a reflective sheet, a brightness enhancement film, and the like to be used for a liquid crystal display is the acrylic film made of an acrylic resin.

2. Description of the Related Art

In recent years, at the time of transporting optical parts/electronic parts or mounting the parts on a printed circuit board, each part has been transported in a state where the part is wrapped with a prescribed sheet or in a state where a pressure-sensitive adhesive tape is attached thereto. Among them, a surface protective film has been particularly widely used in the field of optical/electronic parts.

A surface protective film is used for the purpose of preventing scratches and stains formed at the time of processing or conveyance of a object to be protected while being attached to the object to be protected through a pressure-sensitive adhesive applied generally on a support film side (Patent Document 1). For example, a panel of a liquid crystal display is formed by bonding optical members such as a polarizing plate and a wavelength plate to a liquid crystal cell with a pressure-sensitive adhesive interposed therebetween. These optical members are bonded to a surface protective film with a pressure-sensitive adhesive interposed therebetween, and thus scratches and stains formed at the time of processing or conveyance of a object to be protected are prevented.

The main stream of the polarizing plate is one which is composed of a conventional protective film made of a triacetylcellulose (cellulose triacetate) film (TAC film) and a polarizer having the protective film at least on one surface thereof (Patent Document 2).

However, since the TAC film has high moisture permeability, there is a risk of a problem of deterioration in polarizer if the TAC film is exposed to high temperature and high humidity.

Therefore, a variety of protective films are employed in place of the TAC film, and above all, employment of an acrylic substrate film (acrylic film) with low moisture permeability has been widely conducted (Patent Document 3).

However, if a surface protective film having an acrylic pressure-sensitive adhesive layer is attached to an acrylic substrate film, probably owing to high compatibility of the acrylic substrate film to the acrylic pressure-sensitive adhesive, an increase in adhesive strength over time is caused to lead heavy peeling, and the surface protective film cannot be peeled off from a polarizing plate having the acrylic substrate film, and it may possibly result in a problem in terms of pick-up properties.

### PRIOR ART DOCUMENT

### Patent Documents

[Patent Document 1] JP-A-2001-305346
[Patent Document 2] JP-A-9-258023
[Patent Document 3] JP-A-2010-277039

### SUMMARY OF THE INVENTION

### Problems to be Solved by the Invention

In order to solve the problems with conventional pressure-sensitive adhesive sheets and surface protective films, an object of the present invention is to provide a pressure-sensitive adhesive composition for acrylic film protection which can form a surface protective film (pressure-sensitive adhesive sheet) excellent in antistatic properties, adherability, removability and workability for acrylic films (acrylic resins) and usable for acrylic film protection.

### Means for Solving the Problems

That is, the pressure-sensitive adhesive composition for acrylic film protection according to the present invention (simply may be referred to as pressure-sensitive adhesive composition) is characterized by containing a (meth)acrylic polymer containing a (meth)acrylic monomer having an alkyl group of 1 to 14 carbon atoms in a proportion of 50 to 99.9 wt % as a monomer component, a tri-functional isocyanate crosslinking agent, a di-functional isocyanate crosslinking agent, an organopolysiloxane having oxyalkylene chains, and an ionic compound.

It is preferable that in the pressure-sensitive adhesive composition for acrylic film protection of the present invention, the (meth)acrylic polymer contains a hydroxyl group-containing (meth)acrylic monomer as a monomer component.

It is preferable that in the pressure-sensitive adhesive composition for acrylic film protection of the present invention, the ionic compound is an alkali metal salt and/or an ionic liquid.

It is preferable that the pressure-sensitive adhesive composition for acrylic film protection of the present invention contains an acrylic oligomer.

It is preferable that the surface protective film for acrylic film protection of the present invention has an adhesive strength ratio (B/A) of the adhesive strength (A) at a peel rate of 0.3 m/min after the pressure-sensitive adhesive surface of a pressure-sensitive adhesive layer formed by crosslinking the pressure-sensitive adhesive composition is attached to an acrylic film at 23° C. for 30 minutes and the adhesive strength (B) at a peel rate of 0.3 m/min after the pressure-sensitive adhesive surface of a pressure-sensitive adhesive layer formed by crosslinking the pressure-sensitive adhesive composition is attached to an acrylic film at 60° C. for one week of 2.8 or lower.

It is preferable that the surface protective film for acrylic film protection of the present invention has a support film and a pressure-sensitive adhesive layer formed by crosslinking the pressure-sensitive adhesive composition on at least one surface of the support film.

It is preferable that the optical member of the present invention is protected by the surface protective film for acrylic film protection.

### BRIEF DESCRIPTION OF DRAWINGS

FIG. 1 is a schematic structural drawing of a potential measurement part used for measuring peeling electrification voltage.

### DETAILED DESCRIPTION OF THE PREFERRED EMBODIMENTS

Hereinafter, embodiments of the present invention will be described in detail.

### <Pressure-Sensitive Adhesive Composition for Acrylic Film Protection>

A pressure-sensitive adhesive composition for acrylic film protection according to the present invention (simply may be referred to as pressure-sensitive adhesive composition) is characterized by containing a (meth)acrylic polymer containing a (meth)acrylic monomer having an alkyl group of 1 to 14 carbon atoms in a proportion of 50 to 99.9 wt % as a monomer component, a tri-functional isocyanate crosslinking agent, a di-functional isocyanate crosslinking agent, an organopolysiloxane having oxyalkylene chains, and an ionic compound.

### <(Meth)Acrylic Polymer>

The pressure-sensitive adhesive composition of the present invention contains a (meth)acrylic polymer containing a (meth)acrylic monomer having an alkyl group of 1 to 14 carbon atoms in a proportion of 50 to 99.9 wt %, preferably 60 to 99 wt %, more preferably 70 to 98 wt %, and even more preferably 80 to 97 wt % with respect to the total amount of the monomer components constituting the (meth)acrylic polymer. If the proportion of the (meth)acrylic monomer having an alkyl group of 1 to 14 carbon atoms is within the above-mentioned range, the pressure-sensitive adhesive composition is provided with proper wettability and cohesive strength, and it is therefore preferable.

The (meth)acrylic polymer in the present invention refers to an acrylic polymer and/or a methacrylic polymer, and (meth)acrylate refers to acrylate and/or methacrylate. In addition, one or more kinds of (meth)acrylic monomers may be used as main components.

Specific examples of the (meth)acrylate having an alkyl group of 1 to 14 carbon atoms include methyl (meth)acrylate, ethyl (meth)acrylate, n-butyl (meth)acrylate, s-butyl (meth)acrylate, t-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate and the like.

Particularly when the pressure-sensitive adhesive sheet of the present invention is for use as a surface protecting film, preferred examples include (meth)acrylates having an alkyl group of 6 to 14 carbon atoms, such as hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate and the like. The use of a (meth)acrylate having an alkyl group of 6 to 14 carbon atoms makes it easy to control the adhesive strength to the adherend at a low level, so that excellent removability is achieved. The surface protective film in the present invention refers to include a pressure-sensitive adhesive sheet, a double-sided pressure-sensitive adhesive sheet, a pressure-sensitive adhesive film, etc.

It is preferable that in the pressure-sensitive adhesive composition of the present invention, the (meth)acrylic polymer contains a hydroxyl group-containing (meth)acrylic monomer as a monomer component. Incorporation of the hydroxyl group-containing (meth)acrylic monomer makes crosslinking of the pressure-sensitive adhesive composition controllable and subsequently makes balance between an improvement in wettability owing to the fluidity and a decrease in adhering strength at the time of peeling controllable. Further, different from a carboxyl group and a sulfonate group which can generally react as a crosslinking site, a hydroxyl group properly has interaction with an ionic compound as an antistatic agent and an organopolysiloxane having oxyalkylene chains, and the hydroxyl group-containing (meth)acrylic monomer is thus preferably usable in terms of antistatic properties.

Examples of the hydroxyl group-containing monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl) methylacrylate, N-methylol (meth)acrylamide, vinyl alcohol, allyl alcohol, 2-hydroxyethyl vinyl ether, 4-hydroxybutyl vinyl ether, diethylene glycol monovinyl ether and the like. One or more kinds of the hydroxyl group-containing (meth)acrylic monomers may be used as main components.

The pressure-sensitive adhesive composition contains the hydroxyl group-containing (meth)acrylic monomer in a proportion of preferably 15 wt % or less, more preferably 1 to 13 wt %, even more preferably 2 to 11 wt %, and most preferably 3.5 to 10 wt % with respect to the total amount of the monomer components constituting the (meth)acrylic polymer. If the proportion is within the range, it is made easy to control balance between the wettability of the pressure-sensitive adhesive composition and the cohesive strength of the pressure-sensitive adhesive layer to be obtained, and thus it is preferable.

The pressure-sensitive adhesive composition contains a carboxyl group-containing (meth)acrylic monomer in a proportion of preferably 2 wt % or less, more preferably 1 wt % or less, and even more preferably 0.5 wt % or less with respect to the total amount of the monomer components constituting the (meth)acrylic polymer. If the proportion exceeds 2 wt %, the removability and the workability are inferior, and therefore it is not preferable. Further, in the case where an ionic compound is added as an antistatic agent, if there are many acidic functional groups such as carboxyl groups with high polar action, the acidic functional groups such as carboxyl groups and the ionic compound undergoes interaction to hinder ionic conduction and lower the conduction efficiency, and it may result in failure to obtain sufficient antistatic properties, and thus it is not preferable.

As for other polymerizable monomer components, polymerizable monomers for controlling the glass transition temperature (Tg) or peeling properties of the (meth)acryl-based polymer so that the Tg can be 0° C. or lower (generally −100° C. or higher) may be used in terms of easy balancing of adhesive performance, as long as the effects of the present invention are not reduced.

Other polymerizable monomers other than the (meth)acrylic monomer having an alkyl group of 1 to 14 carbon atoms, the hydroxyl group-containing (meth)acrylic monomer, and the carboxyl group-containing (meth)acrylic monomer to be used in the (meth)acrylic polymer may be used without any particular limitation as long as the properties of the present invention are not deteriorated. Examples of the other polymerizable monomers that can be properly used include components for improving cohesive strength and heat resistance such as a cyano group-containing monomer, a vinyl ester monomer, and an aromatic vinyl monomer; and components having a functional group for improving adhesive strength (adhering strength) or serving as a crosslinking base point such as an amide group-containing monomer, an imide group-containing monomer, an amino group-containing monomer, an epoxy group-containing monomer, N-acryloylmorpholine, and a vinyl ether monomer. These polymerizable monomers may be used alone or in combination of two or more.

Examples of the cyano group-containing monomer include acrylonitrile and methacrylonitrile.

Examples of vinylesters include vinyl acetate, vinyl propionate, and vinyl laurate.

Examples of the aromatic vinyl compound include styrene, chlorostyrene, chloromethylstyrene, α-methylstyrene, and other substituted styrene.

Examples of the amido group-containing monomer include acrylamide, methacrylamide, diethylacrylamide, N-vinylpyrrolidone, N, N-dimethylacrylamide, N, N-dimethylmethacrylamide, N, N-diethylacrylamide, N, N-diethylmethacrylamide, N, N′-methylenebisacrylamide, N, N-dimethylaminopropylacrylamide, N, N-dimethylaminopropylmethacrylamide, and diacetoneacrylamide.

Examples of the imido group-containing monomer include cyclohexylmaleimide, isopropylmaleimide, N-cyclohexylmaleimide, and itaconeimide.

Examples of the amino group-containing monomer include aminoethyl (meth)acrylate, N, N-dimethylaminoethyl (meth)acrylate, and N, N-dimethylaminopropyl (meth)acrylate.

Examples of the epoxy group-containing monomer include glycidyl (meth)acrylate, methylglycidyl (meth)acrylate, and allyl glycidyl ether.

Examples of vinyl ethers include methyl vinyl ether, ethyl vinyl ether, and isobutyl vinyl ether.

In the present invention, the other polymerizable monomers are contained in a proportion of preferably 0 to 40 wt %, and more preferably 0 to 30 wt % with respect to the total amount of the monomer components (all monomer components) constituting the (meth)acrylic polymer. Incorporation of the other polymerizable monomers within the above-mentioned range makes it possible to properly adjust good interaction with the ionic compound to be used as an antistatic agent and good removability.

The (meth)acrylic polymer has a weight average molecular weight (Mw) of 100000 to 5000000, preferably 200000 to 4000000, more preferably 300000 to 3000000, and most preferably 400000 to 1000000. If the weight average molecular weight is lower than 100000, the adhesive residue tends to remain because the cohesive strength of the pressure-sensitive adhesive layer to be obtained is lowered. On the other hand, if the weight average molecular weight exceeds 5000000, the fluidity of the polymer is lowered, the wetting to an adherend (acrylic film or the like) becomes insufficient, and it tends to be a cause of forming blisters between the adherend and the pressure-sensitive adhesive layer (pressure-sensitive adhesive composition layer) of the surface protective film (pressure-sensitive adhesive sheet). In addition, the weight average molecular weight (Mw) is a value measured by GPC (gel permeation chromatography).

The (meth)acrylic polymer has a glass transition temperature (Tg) of preferably 0° C. of lower, and more preferably −10° C. or lower (usually −100° C. or higher). If the glass transition temperature is higher than 0° C., the polymer does not easily flow, and for example, the wetting to an adherend (acrylic film or the like) becomes insufficient, and it tends to be a cause of forming blisters between the adherend and the pressure-sensitive adhesive layer (pressure-sensitive adhesive composition layer) of the surface protective film (pressure-sensitive adhesive sheet). In particular, adjustment of the glass transition temperature to −61° C. or lower makes it easy to obtain a pressure-sensitive adhesive composition excellent in wettability to an adherend and light peelability. The glass transition temperature of the (meth)acrylic polymer can be adjusted within the above-mentioned range by properly varying the monomer components to be used and the composition ratio.

The polymerization method of the (meth)acryl-based polymer is not particularly limited, but for example, a known polymerization method including solution polymerization, emulsion polymerization, bulk polymerization, and suspension polymerization. The solution polymerization is more preferred in view of the workability and specific aspects such as low staining to the object to be protected. The resultant polymer may be any one selected from a random copolymer, a block copolymer, an alternate copolymer, a graft copolymer and others.

### <Ionic Compound>

The pressure-sensitive adhesive composition of the present invention contains an ionic compound, and as the ionic compound, it is preferable to use an alkali metal salt and/or an ionic liquid. Incorporation of these ionic compounds can provide excellent antistatic properties.

It is preferred that the alkali metal salt exhibits excellent antistatic properties even in case of adding a trace amount because of its high ionic dissociation. It is possible to suitably use, as the alkali metal salt, for example, a metal salt composed of cations of Li⁺, Na⁺ and K⁺, and anions of Cl⁻, Br⁻, I⁻, AlCl₄⁻, Al₂Cl₇⁻, BF₄⁻, PF₆⁻, SCN⁻, ClO₄⁻, NO₃⁻, CH₃COO⁻, C₉H₁₉COO⁻, CF₃COO⁻, C₃F₇COO⁻, CH₃SO₃⁻, CF₃SO₃⁻, C₄F₉SO₃⁻, C₂H₅OSO₃⁻, C₆H₁₃OSO₃⁻, C₈H₁₇OSO₃⁻, (CF₃SO₂)₂N⁻, (C₂F₅SO₂)₂N⁻, (C₃F₇SO₂)₂N⁻, (C₄F₉SO₂)₂N⁻, (CF₃SO₂)₃C⁻, AsF₆⁻, SbF₆⁻, NbF₆⁻, TaF₆⁻, F(HF)ₙ⁻, (CN)₂N⁻, (CF₃SO₂) (CF₃CO) N⁻, (CH₃)₂PO₄—, (C₂H₅)₂PO₄—, CH₃ (OC₂H₄)₂OSO₃—, C₆H₄(CH₃)SO₃⁻, (C₂F₅)₃PF₃⁻, CH₃CH(OH) COO⁻ and (FSO₂)₂N⁻. More preferably, lithium salts such as LiBr, LiI, LiBF₄, LiPF₆, LiSCN, LiClO₄, LiCF₃SO₃, Li(CF₃SO₂)₂N, Li(C₂F₅SO₂)₂N, Li(FSO₂)₂N and Li(CF₃SO₂)₃C are used. Still more preferably, LiCF₃SO₃, Li(CF₃SO₂)₂N, Li(C₂F₅SO₂)₂N, Li(C₃F₇SO₂)₂N, Li(C₄F₉SO₂)₂N, Li(FSO₂)₂N and Di(CF₃SO₂)₃C are used. These alkali metal salts may be used alone or in a mixture of two or more.

When using the ionic liquid as an antistatic agent, it is possible to obtain a pressure-sensitive adhesive layer having high antistatic effect without impairing adhesive properties. Although details of the reason why excellent antistatic properties are obtained by use of the ionic liquid are not clear, it is considered that it is easy for the ionic liquid to undergo molecular motion because of its liquid form, and thus excellent antistatic properties are obtained. It is considered that excellent peeling antistatic properties of the adherend is carried out by transferring a trace amount of the ionic liquid to the adherend in case of preventing electrification to the adherend.

Since the ionic liquid is in a state of liquid at room temperature (25° C.), addition and dispersion or dissolution in a pressure-sensitive adhesive can be easily performed as compared with a salt in a state of solid. The ionic liquid has such a feature that antistatic properties can be continuously obtained without losing with the lapse of time because of no vapor pressure (non-volatility). The ionic liquid refers to a melt salt (ionic compound) which is a state of liquid at room temperature (25° C.).

The ionic liquid to be preferably used is composed of organic cation components represented by the following general formulas (A) to (E) and an anion component.

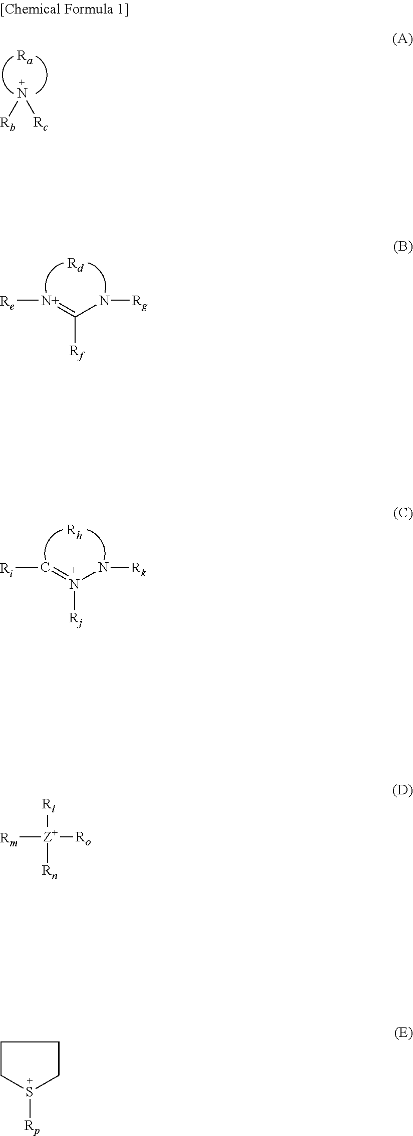

In the formula (A), Rₐ represents a hydrocarbon group of a carbon number of 4 to 20, and may contain a hetero atom, and R_{b} and R_{c} are the same or different, represent hydrogen or a hydrocarbon group of a carbon number of 1 to 16, and may contain a hetero atom, provided that, when a nitrogen atom contains a double bond, R_{c} is not present.

In the formula (B), R_{d} represents a hydrocarbon group of a carbon number of 2 to 20, and may contain a hetero atom, and Rₑ, R_{f} and R_{g} are the same or different, represent hydrogen or a hydrocarbon group of a carbon number of 1 to 16, and may contain a hetero atom.

In the formula (C), Rₕ represents a hydrocarbon group of a carbon number of 2 to 20, and may contain a hetero atom, and Rᵢ, Rⱼ and Rₖ are the same or different, represent a hydrogen or a hydrocarbon group of a carbon number of 1 to 16, and may contain a hetero atom.

In the formula (D), Z represents a nitrogen atom, a sulfur atom, or a phosphorus atom, and Rₗ, Rₘ, Rₘ and Rₒ are the same or different, represent a hydrocarbon group of a carbon number of 1 to 20, and may contain a hetero atom, provided that, when Z is a sulfur atom, Rₒ is not present.

Rₚ in the formula (E) represents a hydrocarbon group of 1 to 18 carbon atoms and may be a functional group in which a part of the hydrocarbon group is substituted with a hetero atom.

Examples of the cation represented by the formula (A) include a pyridinium cation, a piperidinium cation, a pyrrolidinium cation, a cation having a pyrroline skeleton, a cation having a pyrrole skeleton, and a morpholinium cation.

Specific examples thereof include a 1-ethylpyridinium cation, a 1-butylpyridiniumcation, a 1-hexylpyridiniumcation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, a pyrrolidinium-2-on cation, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidiniumcation, a 2-methyl-1-pyrrolinecation, a 1-ethyl-2-phenylindole cation, a 1,2-dimethylindole cation, a 1-ethylcarbazolecation, a N-ethyl-N-methylmorphoniumcation and the like.

Examples of the cation represented by the formula (B) include an imidazolium cation, a tetrahydropyrimidinium cation, and a dihydropyrimidinium cation.

Specific examples thereof include a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-octyl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1-(2-methoxyethyl)-3-methylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, a 1,2,3,4-tetramethyl-1,6-dihydropyrimidinium cation and the like.

Examples of the cation represented by the formula (C) include a pyrazolium cation, and a pyrazolinium cation.

Specific examples include a 1-methylpyrazolium cation, a 3-methylpyrazolium cation, a 1-ethyl-2-methylpyrazolinium cation, a 1-ethyl-2,3,5-trimethylpyrazolium cation, a 1-propyl-2,3,5-trimethylpyrazolium cation, and a 1-butyl-2,3,5-trimethylpyrazolium cation, a 1-ethyl-2,3,5-trimethylpyrazolinium cation, a 1-propyl-2,3,5-trimethylpyrazolinium cation, and a 1-butyl-2,3,5-trimethylpyrazolinium cation.

Examples of the cation represented by the formula (D) include a tetraalkylammonium cation, a trialkylsulfonium cation, a tetraalkylphosphonium cation, and those cations in which a part of the alkyl group is substituted with an alkenyl group, an alkoxyl group, or an epoxy group.

Specific examples thereof include a tetramethylammonium cation, a tetraethylammonium cation, a tetrabutylammonium cation, a tetrapentylammonium cation, a tetrahexylammonium cation, atetraheptylammonium cation, atriethylmethylammonium cation, a tributylethylammonium cation, a trimethyldecylammonium cation, an

N,N-diethyl-N-methyl-N-(2-methoxyethyl)ammonium cation, a glycidyltrimethylammonium cation, a trimethylsulfonium cation, a triethylsulfonium cation, a tributylsulfonium cation, a trihexylsulfonium cation, a diethylmethylsulfonium cation, a dibutylethylsulfonium cation, a dimethyldecylsulfonium cation, a tetramethylphosphonium cation, a tetraethylphosphonium cation, a tetrabutylphosphonium cation, a tetrahexylphosphonium cation, a tetraoctylphosphonium cation, atriethylmethylphosphonium cation, atributylethylphosphonium cation, a trimethyldecylphosphonium cation, a diallyldimethylammonium cation, a tributyl-(2-methoxyethyl)phosphonium cation and the like. Among these cations, preferably used cations are asymmetric tetraalkylammonium cations, trialkylsulfonium cations and tetraalkylphosphonium cation, such as a triethylmethylammonium cation, a tributylethylammonium cation, a trimethyldecylammoniumcation, adiethylmethylsulfoniumcation, a dibutylethylsulfonium cation, a dimethyldecylsulfonium cation, a triethylmethylphosphonium cation, a tributylethylphosphonium cation and a trimethyldecylphosphonium cation; an N,N-diethyl-N-methyl-N-(2-methoxyethyl)ammonium cation, a glycidyltrimethylammonium cation, a diallyldimethylammonium cation, an N,N-dimethyl-N-ethyl-N-propylammonium cation, an N,N-dimethyl-N-ethyl-N-butylammonium cation, an N,N-dimethyl-N-ethyl-N-pentylammonium cation, an N,N-dimethyl-N-ethyl-N-hexylammonium cation, an N,N-dimethyl-N-ethyl-N-heptylammonium cation, an N,N-dimethyl-N-ethyl-N-nonylammonium cation, an N,N-dimethyl-N,N-dipropylammonium cation, an N,N-diethyl-N-propyl-N-butylammonium cation, an N,N-dimethyl-N-propyl-N-pentylammonium cation, an N,N-dimethyl-N-propyl-N-hexylammonium cation, an N,N-dimethyl-N-propyl-N-heptylammonium cation, an N,N-dimethyl-N-butyl-N-hexylammonium cation, an N,N-diethyl-N-butyl-N-heptylammonium cation, an N,N-dimethyl-N-pentyl-N-hexylammonium cation, an N,N-dimethyl-N,N-dihexylammonium cation, a trimethylheptylammonium cation, an N,N-diethyl-N-methyl-N-propylammonium cation, an N,N-diethyl-N-methyl-N-pentylammonium cation, an N,N-diethyl-N-methyl-N-heptylammonium cation, an N,N-diethyl-N-propyl-N-pentylammonium cation, a triethylpropylammonium cation, a triethylpentylammonium cation, a triethylheptylammonium cation, an N,N-dipropyl-N-methyl-N-ethylammonium cation, an N,N-dipropyl-N-methyl-N-pentylammonium cation, an N,N-dipropyl-N-butyl-N-hexylammonium cation, an N,N-dipropyl-N,N-dihexylammonium cation, an N,N-dibutyl-N-methyl-N-pentylammonium cation, an N,N-dibutyl-N-methyl-N-hexylammonium cation, a trioctylmethylammonium cation and a N-methyl-N-ethyl-N-propyl-N-pentylammonium cation.

The cation represented by the formula (E) includes, for example, a sulfonium cation. Specific examples of Rp in the formula (E) include a methyl group, an ethyl group, a propyl group, a butyl group, a hexyl group, an octyl group, a nonyl group, a decyl group, a dodecyl group, a tridecyl group, a tetradecyl group, an octadecyl group and the like.

On the other hand, the anion component is not particularly limited if it is proper for forming the ionic liquid, and examples thereof to be used include Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, CF₃SO₃⁻, C₄F₉SO₃⁻, (CF₃SO₂)₂N⁻, (C₂F₅SO₂)₂N⁻, (C₃F₇SO₂)₂N⁻, (C₄F₉SO₂)₂N⁻, (CF₃SO₂)₃C⁻, ASF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO) N⁻, C₉H₁₉COO⁻, (CH₃)₂PO₄⁻, (C₂H₅)₂PO₄⁻, C₂H₅OSO₃⁻, C₆H₁₃OSO₃⁻, C₈H₁₇OSO₃⁻, CH₃(OC₂H₄)₂OSO₃⁻, C₆H₄(CH₃)SO₃⁻, (C₂F₅)₃PF₃⁻, CH₃CH(OH)COO⁻, and (FSO₂)₂N⁻.

It is also possible to use, as an anion component, an anion represented by the following formula (F).

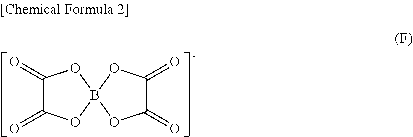

An anion component having a fluorine atom is particularly preferably used as the anion component since an ionic liquid having a low melting point can be obtained.

The ionic liquid used in the present invention is appropriately selected from a combination of the cation component and the anion component, and specific examples thereof include 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 1,1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-diproylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-butylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1,1-dipropylpiperidinium bis(pentafluoroethanesulfonyl)imide, 1-propyl-1-butylpiperidinium bis(pentafluoroethanesulfonyl)imide, 1,1-dibutylpiperidinium bis(pentafluoroethanesulfonyl)imide, 2-methyl-1-pyrroline tetrafluoroborate, 1-ethyl-2-phenylindole tetrafluoroborate, 1,2-dimethylindole tetrafluoroborate, 1-ethylcarbazole tetrafluoroborate, 1-ethyl-3-methylimidazolium tetrafluoroborate, 1-ethyl-3-methylimidazolium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium perfluorobutanesulfonate, 1-ethyl-3-methylimidazolium dicyanamide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimidazolium trifluoromethanesulfonate, 1-butyl-3-methylimidazolium perfluorobutanesulfonate, 1-butyl-3-methylimidazolium bis(trifluoromethanesulfonyl)imide, 1-hexyl-3-methylimidazolium bromide, 1-hexyl-3-methylimidazolium chloride, 1-hexyl-3-methylimidazolium tetrafluoroborate, 1-hexyl-3-methylimidazolium hexafluorophosphate, 1-hexyl-3-methylimidazolium trifluoromethanesulfonate, 1-octyl-3-methylimidazolium tetrafluoroborate, 1-octyl-3-methylimidazolium hexafluorophosphate, 1-hexyl-2,3-dimethylimidazolium tetrafluoroborate, 1,2-dimethyl-3-propylimidazolium bis(trifluoromethanesulfonyl)imide, 1-methylpyrazolium tetrafluoroborate, 2-methylpyrazolium tetrafluoroborate, 1-ethyl-2,3,5-trimethylpyrazolium bis(trifluoromethanesulfonyl)imide, 1-propyl-2,3,5-trimethylpyrazolium bis(trifluoromethanesulfonyl)imide, 1-butyl-2,3,5-trimethylpyrazolium bis(trifluoromethanesulfonyl)imide, 1-ethyl-2,3,5-trimethylpyrazolium bis(pentafluoroethanesulfonyl)imide, 1-propyl-2,3,5-trimethylpyrazolium bis(pentafluoroethanesulfonyl)imide, 1-butyl-2,3,5-trimethylpyrazolium bis(pentafluoroethanesulfonyl)imide, 1-ethyl-2,3,5-trimethylpyrazolium bis(trifluoromethanesulfonyl)trifluoroacetamide, 1-propyl-2,3,5-trimethylpyrazolium bis(trifluoromethanesulfonyl)trifluoroacetamide, 1-butyl-2,3,5-trimethylpyrazolium bis(trifluoromethanesulfonyl)trifluoroacetamide, 1-ethyl-2,3,5-trimethylpyrazolinium bis(trifluoromethanesulfonyl)imide, 1-propyl-2,3,5-trimethylpyrazolinium bis(trifluoromethanesulfonyl)imide, 1-butyl-2,3,5-trimethylpyrazolinium bis(trifluoromethanesulfonyl)imide, 1-ethyl-2,3,5-trimethylpyrazolinium bis(pentafluoroethanesulfonyl)imide, 1-propyl-2,3,5-trimethylpyrazolinium bis(pentafluoroethanesulfonyl)imide, 1-butyl-2,3,5-trimethylpyrazolinium bis(pentafluoroethanesulfonyl)imide, 1-ethyl-2,3,5-trimethylpyrazolinium bis(trifluoromethanesulfonyl)trifluoroacetamide, 1-propyl-2,3,5-trimethylpyrazolinium bis(trifluoromethanesulfonyl)trifluoroacetamide, 1-butyl-2,3,5-trimethylpyrazolinium bis(trifluoromethanesulfonyl)trifluoroacetamide, tetrapentylammonium trifluoromethanesulfonate, tetrapentylammonium bis(trifluoromethanesulfofonyl)imide, tetrahexylammonium trifluoromethanesulfonate, tetrahexylammonium bis(trifluoromethanesulfonyl)imide, tetrabutylammonium trifluoromethanesulfonate, tetraheptylammonium bis(trifluoromethanesulfonyl)imide, diallyldimethylammonium tetrafluoroborate, diallyldimethylammonium trifluoromethanesulfonate, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium tetrafluoroborate, N,N-diethyl-N-methyl-N-(2-methoxyethyl)ammonium trifluoromethanesulfonate, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium trifluoromethanesulfonate, glycidyltrimethylammonium bis(trifluoromethanesulfonyl)imide, glycidyltrimethylammonium bis(pentafluoroethanesulfonyl)imide, tetraoctylphosphonium trifluoromethanesulfonate, tetraoctylphosphonium bis(trifluoromethanesulfonyl)imide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, 1-butylpyridinium (trifluoromethanesulfonyl)trifluoroacetamide, 1-butyl-3-methylpyridinium (trifluoromethanesulfonyl)trifluoroacetamide, 1-ethyl-3-methylimidazolium (trifluoromethanesulfonyl)trifluoroacetamide, N-ethyl-N-methylmorpholinium thiocyanate, 4-ethyl-4-methylmorpholinium methylcarbonate and the like.

As the aforementioned ionic liquid, a commercially available ionic liquid may be used, or the liquid may be synthesized as described below. A method of synthesizing an ionic liquid is not particularly limited as far as an objective ionic liquid is obtained. Generally, a halide method, a hydroxide method, an acid ester method, a chelate forming method, and a neutralization method described in the publication “Ionic liquid—The Front and Future of Development—” (published by CMC) are used.

Regarding a halide method, a hydroxide method, an acid ester method, a chelate forming method, and a neutralization method, a synthesis method using an example of a nitrogen-containing onium salt will be shown below, but other ionic liquid such as a sulfur-containing onium salt, and a phosphorus-containing onium salt can be obtained by the similar procedure.

The halide method is a method which is performed by a reaction shown in the following formulas (1) to (3). First, a tertiary amine and alkyl halide are reacted to obtain halide (Reaction Equation (1), as a halogen, chlorine, bromine or iodine is used). The resulting halide is reacted with an acid (HA) having an anion structure (A⁻) of an objective ionic liquid or a salt (MA, M is a cation forming a salt with an objective anion such as ammonium, lithium, sodium and potassium) of an objective ionic liquid to obtain an objective ionic liquid (R₄NA).

[Chemical formula 3]

R₃N+RX→R₄NX (X: Cl, Br, I) (1)

R₄NX+HA→R₄NA+HX (2)

R₄NX+MA→R₄NA+MX (M: NH₄, Li, Na, K, Ag etc.) (3)

The hydroxide method is a method performed by a reaction shown in (4) to (8). First, a halide (R₄NX) is subjected to ion exchange membrane method electrolysis (reaction equation (4)), an OH-type ion exchange resin method (reaction equation (5)) or a reaction with silver oxide (Ag₂O) (reaction equation (6)) to obtain a hydroxide (R₄NOH) (as a halogen, chlorine, bromine or iodine is used). The resulting hydroxide is subjected to a reaction of reaction equations (7) to (8) as in the aforementioned halide method to obtain an objective ionic liquid (R₄NA).

[Chemical formula 4]

R₄NX+H₂O→R₄NOH+½H₂+½X₂ (X: Cl, Br, I) (4)

R₄NX+P—OH→R₄NOH+P-X (P-OH: OH-type ion exchange resin) (5)

R₄NX+½Ag₂O+½H₂O→R₄NOH+AgX (6)

R₄NOH+HA→R₄NA+H₂O (7)

R₄NOH+MA→R₄NA+MOH (M: NH₄, Li, Na, K, Ag etc.) (8)

The acid ester method is a method performed by a reaction shown in (9) to (11). First, tertiary amine (R₃N) is reacted with acid ester to obtain an acid esterified substance (reaction equation (9), as acid ester, ester of an inorganic acid such as sulfuric acid, sulfurous acid, phosphoric acid, phosphorous acid, and carbonic acid, or ester of organic acid such as methanesulfonic acid, methylphosphonic acid and formic acid is used). The resulting acid esterified substance is subjected to a reaction of reaction equations (10) to (11) as in the aforementioned halide method, to obtain an objective ionic liquid (R₄NA). Alternatively, as acid ester, methyl trifluoromethane sulfonate, or methyl trifluoroacetate may be used to directly obtain an ionic liquid.

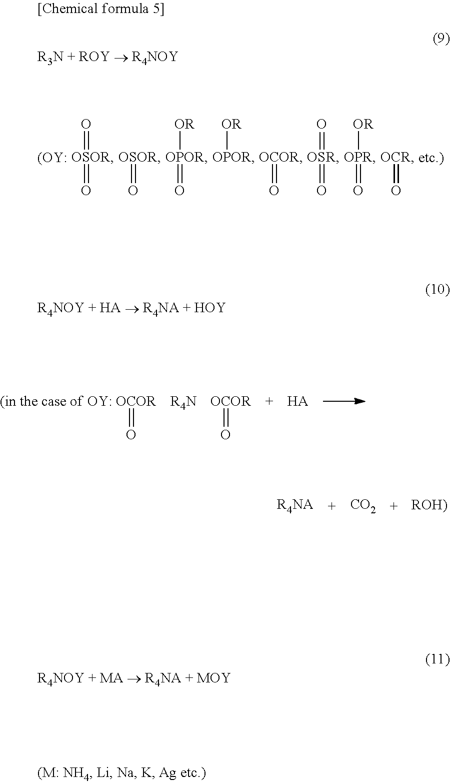

The chelate forming method is a method performed by a reaction as shown in (12) to (15). First, halide of quaternary ammonium (R₄NX), hydroxide of quaternary ammonium (R₄NOH), or carbonic acid esterified substance of quaternary ammonium (R₄NOCO₂CH₃) is reacted with hydrogen fluoride (HF) or ammonium fluoride (NH₄F) to obtain a quaternary ammonium fluoride salt (reaction equation (12) to (14)). The resulting quaternary ammonium fluoride salt can be subjected to a chelate forming reaction with fluoride such as BF₃, AlF₃, PF₅, AsF₅, SbF₅, NbF₅ and TaF₆, to obtain an ionic liquid (reaction equation (15)).

[Chemical formula 6]

R₄NX+HF→R₄NF+HX (X: Cl, Br, I) (12)

R₄NY+HF→R₄NF+HY (Y: OH, OCO₂CH₃) (13)

R₄NY+NH₄F→R₄NF+NH₃+HY (Y: OH, OCO₂CH₃) (14)

R₄NF+MFₙ₋₁→R₄NMFₙ (15)

### (MFₙ₋₁: BF₃, AlF₃, PF₅, AsF₅, SbF₅, NbF₅, TaF₅ etc.)

The neutralization method is a method performed by a reaction shown in (16). An ionic liquid can be obtained by reacting tertiary amine and an organic acid such as HBF₄, HPF₆, CH₃COOH, CF₃COOH, CF₃SO₃H, (CF₃SO₂)₂NH, (CF₃SO₂)₃CH, and (C₂F₅SO₂)₂NH.

[Chemical formula 7]

R₃N+HZ→R₃HN⁺Z⁻ (16)

[HZ: HBF₄, HPF₆, CH₃COOH, CF₃COOH, CF₃SO₃H, (CF₃SO₂)₂NH, (CF₃SO₂)₃CH, (C₂F₅SO₂)₂NH organic acid such as]

The aforementioned R in (1) to (16) represents hydrogen or a hydrocarbon group of a carbon number of 1 to 20, and a part of the hydrocarbon group may be functional group substituted with a hetero atom.

The ionic liquids may be used alone or in combination of two or more.

The content of the ionic compound is preferably 1 part by weight or lower, more preferably 0.001 to 0.9 parts by weight, and furthermore preferably 0.005 to 0.8 parts by weight with respect to 100 parts by weight of the (meth)acrylic polymer. If the content is within the range, it is easy to satisfy both the antistatic properties and the less-staining properties at the same time, and therefore it is preferable.

### <Organopolysiloxane Having Oxyalkylene Chains>

The pressure-sensitive adhesive composition of the present invention contains an organopolysiloxane having oxyalkylene chains. It is presumed that use of the organopolysiloxane lowers the surface free energy of the pressure-sensitive adhesive surface and achieves the light peelability at the time of high speed peeling (e.g., at a peel rate of 30 m/min).

As the organopolysiloxane, known organopolysiloxanes having polyoxyalkylene main chain may be used properly, and those represented by the following formulas are preferable.

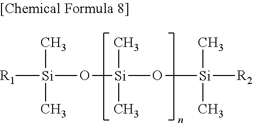

wherein R₁ and/or R₂ have/has an oxyalkylene chain of 1 to 6 carbon atoms, an alkylene group in the oxyalkylene chain may be a straight or branched chain and the oxyalkylene chain may have an alkoxy group or a hydroxyl group at the end, and any one of R₁ or R₂ may be a hydroxyl group or an alkyl group or an alkoxy group, and a part of the alkyl group and alkoxy group may be a functional group substituted with a hetero atom; and n is an integer of 1 to 300.

The organopolysiloxane used is an organopolysiloxane in which a moiety containing siloxane (siloxane moiety) is a main chain and an oxyalkylene chain is bonded to the terminal of the main chain. It is supposed that use of the organosiloxane having the oxyalkylene chain makes it possible to keep balance of compatibility with the (meth)acryl-based polymer and the ionic compound and achieves the light peelability.

It is possible to use, as the organopolysiloxane in the present invention, for example, those with the following constitution. Specifically, R₁ and/or R₂ in the formula has an oxyalkylene chain containing a hydrocarbon group of 1 to 6 carbon atoms, and examples of the oxyalkylene chain include an oxymethylene group, an oxyethylene group, an oxypropylene group, an oxybutylene group and the like. In particular, an oxyethylene group and an oxypropylene group are preferable. When both R₁ and R₂ have an oxyalkylene chain, they may be the same or different.

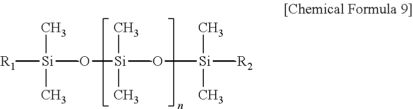

The hydrocarbon group of the oxyalkylene chain may be a straight or branched chain.

The terminal of the oxyalkylene chain may be either an alkoxy group or a hydroxyl group and is especially preferably an alkoxy group. In the case a separator is bonded to the surface of a pressure-sensitive adhesive layer for the purpose of protecting the pressure-sensitive surface, if an organopolysiloxane has a hydroxyl group at the terminal, an interaction with the separator occurs and thus the adhesive strength (peel strength) may sometimes increase at the time of peeling the separator off the surface of the pressure-sensitive adhesive layer.

n is an integer of 1 to 300 and is preferably from 10 to 200, and more preferably from 20 to 150. If n is within the above range, balanced compatibility with a base polymer is achieved, resulting in preferred aspect. It is also possible to have a reactive substituent such as a (meth)acryloyl group, an allyl group or a hydroxyl group in the molecule. The organopolysiloxane may be used alone or in a mixture of two or more.

Specific examples of the organopolysiloxane having the oxyalkylene chain include commercially available products such as X-22-4952, X-22-4272, X-22-6266, KF-6004 and KF-889 (all manufactured by Shin-Etsu Chemical Co., Ltd.); BY16-201 and SF8427 (all manufactured by Dow Corning Toray Co., Ltd.); and IM22 (all manufactured by Wacker Asahikasei Silicone Co., Ltd.). These compounds may be used alone or in a mixture of two or more.

It is also possible to use an organosiloxane having (bonded to) an oxyalkylene chain as a side chain other than the organosiloxane having (bonded to) an oxyalkylene chain as a main chain, and use of an organosiloxane having an oxyalkylene chain in aside chain rather than in a main chain is a more preferable embodiment. A conventionally known organopolysiloxane having a polyoxyalkylene side chain may be used properly as the organopolysiloxane, and those defined by the following formula are preferable.

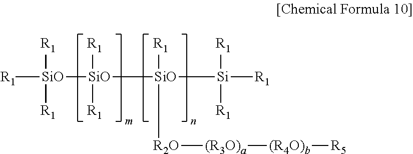

(wherein R₁ is a monovalent organic group; R₂, R₃ and R₄ are an alkylene group; R₅ is a hydroxyl group or an organic group; m and n are an integer of 0 to 1000 and are not simultaneously 0; and a and b are an integer of 0 to 100 and are not simultaneously 0).

Those used as the organopolysiloxane in the present invention have the following constitution, for example. Specifically, in the formula, R₁ is a monovalent organic group, e.g., an alkyl group such as a methyl group, an ethyl group, or a propyl group; an aryl group such as a phenyl group or a tolyl group; or an aralkyl group such as a benzyl group or a phenethyl group, all of which may have a substituent such as a hydroxyl group. R₂, R₃, and R₄ may be an alkylene group of 1 to 8 carbon atoms such as a methylene group, an ethylene group, or a propylene group. In addition, R₃ and R₄ are different alkylene groups and R₂ may be same as or different from R₃ or R₄. Either one of R₃ and R₄ is preferably an ethylene group or a propylene group in order to increase the concentration of an ionic compound soluble in the polyoxyalkylene side chain of the organopolysiloxane. R₅ may be a monovalent organic group, e.g., an alkyl group such as a methyl group, an ethyl group, or a propyl group, or an acyl group such as an acetyl group or a propionyl group, which may respectively have a substituent such as a hydroxyl group. These compounds may be used alone or in form of a mixture of two or more thereof. These compounds may have a reactive substituent such as a (meth)acryloyl group, an allyl group, or a hydroxyl group in the molecule. An organosiloxane having a polyoxyalkylene side chain having a hydroxyl group at the terminal is particularly preferable among the organosiloxanes having a polyoxyalkylene side chain since it is supposed that the compatibility can be easily well balanced.

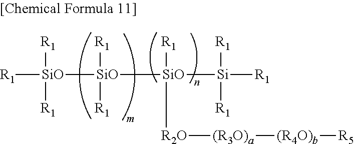

Specific examples of the organosiloxane include commercially available products such as KF-351A, KF-352A, KF-353, KF-354L, KF-355A, KF-615A, KF-945, KF-640, KF-642, KF-643, KF-6022, X-22-6191, X-22-4515, KF-6011, KF-6012, KF-6015, KF-6017, and X-22-2516 (all manufactured by Shin-Etsu Chemical Co., Ltd.); SF8428, FZ-2162, SH3749, FZ-77, L-7001, FZ-2104, FZ-2110, L-7002, FZ-2122, FZ-2164, FZ-2203, FZ-7001, SH8400, SH8700, SF8410, and SF8422 (all manufactured by Dow Corning Toray Co., Ltd.); TSF-4440, TSF-4441, TSF-4445, TSF-4450, TSF-4446, TSF-4452, and TSF-4460 (all manufactured by Momentive Performance Materials Inc.); and BYK-333, BYK-307, BYK-377, BYK-UV3500, and BYK-UV3570 (all manufactured by BYK Japan KK). These compounds may be used alone or in form of a mixture of two or more thereof.

The organosiloxane used in the present invention has an HLB (Hydrophile-Lipophile Balance) value of preferably 1 to 16 and more preferably 3 to 14. If the HLB value is out of the range, the staining property to the adherend is worsened and thus it is not preferable.

The content of the organopolysiloxane to 100 parts by weight of the (meth)acryl-based polymer is preferably 0.01 to 5 parts by weight, more preferably 0.03 to 3 parts by weight, and furthermore preferably 0.05 to 1 part by weight. It is preferred that the content is within the above-mentioned range since it is easy to achieve both antistatic property and light peelability (removability).

### <Crosslinking Agent>

The pressure-sensitive adhesive composition of the present invention contains, as a crosslinking agent, a tri-functional isocyanate crosslinking agent (compound) and a di-functional isocyanate crosslinking agent (compound) in combination. Combination use of the isocyanate crosslinking agents (compounds) makes adjustment of adhesive strength easy, and suppresses an increase in adhesive strength even in the case of leaving the composition for a long time in heating environments (e.g., at 60° C. for one week or the like), and provides a preferable embodiment of the present invention. Further, in the present invention, a pressure-sensitive adhesive layer is formed by using the pressure-sensitive adhesive composition. The constituent units and constituent ratio for the (meth)acrylic polymer and the selection and addition ratio of the crosslinking agents, etc., are properly adjusted to carry out crosslinking so that a surface protective film (pressure-sensitive adhesive sheet, pressure-sensitive adhesive layer) more excellent in heat resistance can be obtained.

Examples of the tri-functional isocyanate crosslinking agent (compound) include a trimethylolpropane/tolylene diisocyanate trimer adduct, a trimethylolpropane/hexamethylene diisocyanate trimer adduct, an isocyanurate of hexamethylene diisocyanate, a biuret modified product of hexamethylene diisocyanate, an allophanate modified product of hexamethylene diisocyanate and a uretdione modified product of hexamethylene diisocyanate. Examples thereof as a commercialized product include CORONATE L, CORONATE HL, and CORONATE HX (all manufactured by Nippon Polyurethane Industry Co., Ltd.), TAKENATE D165N and TAKENATE D178N (all manufactured by Mitsui Chemicals, Inc.), and Desmodur N3400 (manufactured by Sumitomo Bayer Urethane Co., Ltd.). These tri-functional isocyanate compounds may be used alone or in combination of two or more.

Examples of the di-functional isocyanate crosslinking agent (compound) include aliphatic polyisocyanates such as trimethylene diisocyanate, butylene diisocyanate, hexamethylene diisocyanate (HDI), and dimer acid diisocyanurate; aliphatic isocyanates such as cyclopentylene diisocyanate, cyclohexylene diisocyanate, and isophorone diisocyanate (IPDI); aromatic isocyanates such as 2,4-tolylene diisocyanate, 4,4′-diphenylmethane diisocyanate, xylylene diisocyanate (XDI), and 1,3-bis(isocyanatomethyl)benzene; and alicyclic isocyanates such as 1,3-bis(isocyanatomethyl)cyclohexane. Examples thereof as a commercialized product include TAKENATE 500 and TAKENATE 600 (all manufactured by Mitsui Chemicals, Inc.) and Millionate MT and CORONATE T (all manufactured by Nippon Polyurethane Industry Co., Ltd.). These di-functional isocyanate compounds may be used alone or in combination of two or more.

As the crosslinking agent to be used for the present invention, besides the bi-functional and tri-functional isocyanate compounds, an epoxy compound, a melamine-based resin, an aziridine derivative, a metal chelate compound, etc., may be used to an extent that the characteristics of the present invention are not particularly affected. These compounds may be used alone or in combination of two or more.

Examples of the epoxy compound include N,N,N′,N′-tetraglycidyl-m-xylenediamine (trade name TETRAD-X manufactured by Mitsubishi Gas Chemical Company, Inc.) and 1,3-bis(N,N-diglycidylaminomethyl)cyclohexane (trade name TETRAD-C manufactured by Mitsubishi Gas Chemical Company Inc.).

Examples of the melamine-based resin include hexamethylolmelamine. Examples of the aziridine derivative include trade name HDU (manufactured by Sago Pharmaceutical Co., Ltd.), trade name TAZM (manufactured by Sago Pharmaceutical Co., Ltd.), and trade name TAZO (manufactured by Sago Pharmaceutical Co., Ltd.) as a commercially available product.

Metal chelate compounds include a metal component such as aluminum, iron, tin, titanium, or nickel, and a chelate component such as acetylene, methyl acetoacetate, or ethyl lactate.

The content (total) of the crosslinking agents to be used for the present invention is preferably 0.1 to 15 parts by weight, more preferably 0.5 to 10 parts by weight, further more preferably 1 to 8 parts by weight, and most preferably 1.5 to 7 parts by weight with respect to 100 parts by weight of the (meth)acrylic polymer. If the content is lower than 0.1 parts by weight, the crosslink formation by the crosslinking agents may become insufficient, the cohesive strength of the pressure-sensitive adhesive layer may be low, it may not be possible to obtain sufficient heat resistance, and further, it tends to be a cause of adhesive residue. On the other hand, if the content exceeds 15 parts by weight, the cohesive strength of the pressure-sensitive adhesive layer may become high, the fluidity may be lowered, the wetting to an adherend (acrylic film or the like) may become insufficient, and it tends to be a cause of forming blisters between the adherend and the pressure-sensitive adhesive layer (pressure-sensitive adhesive composition layer) of the surface protective film (pressure-sensitive adhesive sheet). Further, if the crosslinking agent amount is high, the peeling electrification properties tend to be deteriorated.

The mixing ratio of the tri-functional isocyanate crosslinking agent and the di-functional isocyanate crosslinking agent to be used for the present invention is not particularly limited in the case of using the crosslinking agents in combination, but for example, it is preferable to use 0.08 to 14 parts by weight of the tri-functional isocyanate crosslinking agent and 0.02 to 2 parts by weight of the di-functional isocyanate crosslinking agent; more preferably 0.4 to 9 parts by weight of the tri-functional isocyanate crosslinking agent and 0.1 to 1.5 parts by weight of the di-functional isocyanate crosslinking agent; and furthermore preferably 0.8 to 7 parts by weight of the tri-functional isocyanate crosslinking agent and 0.2 to 1 part by weight of the di-functional isocyanate crosslinking agent with respect to 100 parts by weight of the (meth)acrylic polymer. Use of the crosslinking agents in amounts adjusted within the ranges is advantageous since proper adhesive strength can be obtained without an excess increase in adhesive strength to an acrylic film (acrylic resin) having high compatibility with an acrylic pressure-sensitive adhesive (that is, accompanies an increase in adhesive strength). Particularly, even in the case where a pressure-sensitive adhesive layer formed by using the acrylic pressure-sensitive adhesive is attached to the acrylic film and thereafter left in a heating condition, an excess increase in adhesive strength can be suppressed, and therefore it is advantageous. The reasons in detail for such suppression of an increase in adhesive strength are not clear, but it is presumed that combination use of the tri-functional isocyanate crosslinking agent and the di-functional isocyanate crosslinking agent can form an advanced crosslinking structure and an increase in adhesive strength can be suppressed.

In the present invention, the pressure-sensitive adhesive layer has a gel fraction (ratio of solvent-insoluble component) of preferably 70 to 99 wt % and more preferably 80 to 98 wt %. If the gel fraction is lower than 70 wt %, the cohesive strength of the pressure-sensitive adhesive layer may become insufficient, and stains may be formed at the time of peeling off the pressure-sensitive adhesive layer from an adherend (object to be protected) (acrylic film or the like), and on the other hand, if the gel fraction exceeds 99 wt %, the cohesive strength of the pressure-sensitive adhesive layer becomes too high, the fluidity is lowered, and the wetting to an adherend (acrylic film or the like) becomes insufficient.

### <Measurement of Gel Fraction (Ratio of Solvent-Insoluble Component)>

The gel fraction is calculated by accurately measuring the weight of 0.1 g of the pressure-sensitive adhesive layer as a sample (weight before immersion); immersing the sample in about 50 ml of ethyl acetate at room temperature (20 to 25° C.) for one week; thereafter, taking out a solvent (ethyl acetate)-insoluble matter; drying the solvent-insoluble matter at 130° C. for two hours; measuring the weight (weight after immersion and drying); and using the following gel fraction (solvent-insoluble component ratio) calculation expression (1).

Gel fraction (ratio of solvent-insoluble component) (wt %)=[(weight after immersion and drying)/(weight before immersion)]×100 (1)

The pressure-sensitive adhesive composition may further contain a crosslinking catalyst for more effectively promoting the crosslinking reaction. Examples of the crosslinking catalyst that can be used include tin-based catalysts such as dibutyltin dilaurate and dioctyltin dilaurate and iron-based catalysts such as tris(acetylacetonato)iron, tris(hexane-2,4-dionato)iron, tris(heptane2,4-dionato)iron, tris(heptane3,5-dionato)iron, tris(5-methylhexane-2,4-dionato)iron, tris(octane-2,4-dionato)iron, tris(6-methylheptane-2,4-dionato)iron, tris(2,6-dimethylheptane-3,5-dionato)iron, tris(nonane-2,4-dionato)iron, tris(nonane-4,6-dionato)iron, tris(2,2,6,6-tetramethylheptane-3,5-dionato)iron, tris(tridecane-6,8-dionato)iron, tris(1-phenylbutane-1,3-dionato)iron, tris(hexafluoroacetylacetonato)iron, tris(acetoacetic acid ethyl ester)iron, tris(acetoacetic acid n-propyl ester)iron, tris(acetoacetic acid isopropyl ester)iron, tris(acetoacetic acid n-butyl ester)iron, tris(acetoacetic acid sec-butyl ester)iron, tris(acetoacetic acid tert-butyl ester)iron, tris(propionylacetic acid methyl ester)iron, tris(propionylacetic acid ethyl ester)iron, tris(propionylacetic acid n-propyl ester)iron, tris(propionylacetic acid isopropyl ester)iron, tris(propionylacetic acid n-butyl ester)iron, tris(propionylacetic acid sec-butyl ester)iron, tris(propionylacetic acid tert-butyl ester)iron, tris(acetoacetic acid benzyl ester)iron, tris(malonic acid dimethyl ester)iron, tris(malonic acid diethyl ester)iron, trimethoxyiron, triethoxyiron, tri-isopropoxyiron, and ferric chloride. These crosslinking catalysts may be used alone or in combination of two or more.

The content (use amount) of the crosslinking catalyst is not particularly limited, and preferably about 0.0001 to 1 part by weight and more preferably 0.001 to 0.5 parts by weight with respect to 100 parts by weight of the (meth)acrylic polymer. If the content is within the range, the crosslinking reaction rate is high at the time of forming the pressure-sensitive adhesive layer, and the pot life of the pressure-sensitive adhesive composition is prolonged, and it may result in a preferable embodiment.

The pressure-sensitive adhesive composition of the present invention may contain a polyoxyalkylene chain-containing compound containing no organopolysiloxane. Incorporation of the compound to the pressure-sensitive adhesive composition can provide a pressure-sensitive adhesive composition with more excellent wettability to an adherend.

Specific examples of the polyoxyalkylene chain-containing compound excluding an organopolysiloxane include nonionic surfactants such as polyoxyalkylenealkylamine, polyoxyalkylenediamine, polyoxyalkylene fatty acid ester, polyoxyalkylenesorbitan fatty acid ester, polyoxyalkylene alkyl phenyl ether, polyoxyalkylene alkyl ether, polyoxyalkylene alkyl allyl ether, and polyoxyalkylene alkyl phenyl allyl ether; anionic surfactants such as polyoxyalkylene alkyl ether sulfuric acid ester salt, polyoxyalkylene alkyl ether phosphoric acid ester salt, polyoxyalkylene alkyl phenyl ether sulfuric acid ester salt, and polyoxyalkylene alkyl phenyl ether phosphoric acid ester salt; cationic surfactants and amphoteric surfactants having a polyoxyalkylene chain (polyalkylene oxide chain), polyether compounds (including their derivatives) having a polyoxyalkylene chain, and acrylic compounds (including their derivatives) having a polyoxyalkylene chain. Further, a polyoxyalkylene chain-containing monomer may be added as the polyoxyalkylene chain-containing compound to an acryl-based polymer. These polyoxyalkylene chain-containing compounds may be used alone or in form of a mixture of two or more thereof.

Specific examples of the polyoxyalkylene chain-containing polyether compounds include polypropylene glycol (PPG)-polyethylene glycol (PEG) block copolymers, PPG-PEG-PPG block copolymers, and PEG-PPG-PEG block copolymers. Examples of the polyoxyalkylene chain-containing polyether compound derivatives include terminal-etherified oxypropylene group-containing compounds (PPG monoalkyl ether, PEG-PPG monoalkyl ether, etc.), and terminal-acetylated oxypropylene group-containing compounds (terminal-acetylated PPG, etc.).

Specific examples of the polyoxyalkylene chain-containing acrylic compounds include oxyalkylene group-containing (meth)acrylate polymers. The number of moles added of an oxyalkylene unit for the oxyalkylene group is preferably 1 to 50, more preferably 2 to 30, and furthermore preferably 2 to 20 in terms of coordination of the ionic compound. The terminal of the oxyalkylene chain may be a hydroxyl group as it is or substituted with an alkyl group, a phenyl group, or the like.

The oxyalkylene group-containing (meth)acrylate polymers are preferably polymers containing (meth)acrylic acid alkylene oxide as a monomer unit (component). Specific examples of the (meth)acrylic acid alkylene oxide include, as ethylene glycol group-containing (meth)acrylate, methoxy-polyethylene glycol (meth)acrylate types such as methoxy-diethylene glycol (meth)acrylate and methoxy-triethylene glycol (meth)acrylate; ethoxy-polyethylene glycol (meth)acrylate types such as ethoxy-diethylene glycol (meth)acrylate and ethoxy-triethylene glycol (meth)acrylate; butoxy-polyethylene glycol (meth)acrylate types such as butoxy-diethylene glycol (meth)acrylate and butoxy-triethylene glycol (meth)acrylate; phenoxy-polyethylene glycol (meth)acrylate types such as phenoxy-diethylene glycol (meth)acrylate and phenoxy-triethylene glycol (meth)acrylate; 2-ethylhexyl-polyethylene glycol (meth)acrylate, nonylphenol-polyethylene glycol (meth)acrylate type, and methoxy-polypropylene glycol (meth)acrylate types such as methoxy-dipropylene glycol (meth)acrylate.

Other monomer units (components) other than the (meth)acrylic acid alkylene oxide may be used as the monomer unit (component). Specific examples of other monomer components include acrylates and/or methacrylates having an alkyl group of 1 to 14 carbon atoms such as methyl (meth)acrylate, ethyl (meth)acrylate, n-butyl (meth)acrylate, sec-butyl (meth)acrylate, tert-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, and n-tetradecyl (meth)acrylate.

Further, it is also possible to properly use carboxyl group-containing (meth)acrylate, phosphoric acid group-containing (meth)acrylate, cyano group-containing (meth)acrylate, vinyl esters, aromatic vinyl compounds, acid anhydride group-containing (meth)acrylate, hydroxyl group-containing (meth)acrylate, amide group-containing (meth)acrylate, amino group-containing (meth)acrylate, epoxy group-containing (meth)acrylate, N-acryloylmorpholine, and vinyl ethers as another monomer unit (component) other than the (meth)acrylic acid alkylene oxide.

In a preferred embodiment, the polyoxyalkylene chain-containing compound excluding an organopolysiloxane is a compound which at least partially has a (poly)ethylene oxide chain. Addition of the (poly)ethylene oxide chain-containing compound improves compatibility between a base polymer and an antistatic component and suppresses bleeding to the adherend successfully and thus gives a pressure-sensitive adhesive composition with a low staining property. In particular, in the case of using a PPG-PEG-PPG block copolymer, a pressure-sensitive adhesive composition excellent in the low staining property can be obtained. In the polyethylene oxide chain-containing compound, the weight ratio of the (poly)ethylene oxide chain to the total weight of the polyoxyalkylene chain-containing compounds excluding an organopolysiloxane is preferably 5 to 90% by weight, more preferably 5 to 85% by weight, furthermore preferably 5 to 80% by weight, and most preferably 5 to 75% by weight.

The polyoxyalkylene chain-containing compound excluding an organopolysiloxane has a number average molecular weight (Mn) of suitably 50,000 or less, preferably 200 to 30,000, more preferably 200 to 10,000, and even more preferably 200 to 5,000. If Mn is excessively larger than 50,000, the compatibility with an acryl-based polymer tends to be lowered, resulting in whitening of the pressure-sensitive adhesive layer. If Mn is excessively smaller than 200, staining with the polyoxyalkylene compound may be likely to occur. Herein, Mn refers to a polystyrene-equivalent value measured by GPC (gel permeation chromatography).

Specific examples of commercially available products of the polyoxyalkylene chain-containing compound excluding an organopolysiloxane include ADEKA Pluronic 17R-4 and ADEKA Pluronic 25R-2 (both manufactured by ADEKA); and Emulgen 120 (manufactured by KAO Corporation).

The addition amount of the polyoxyalkylene chain-containing compound containing no organopolysiloxane is, for example, 0.005 to 20 parts by weight, preferably 0.01 to 10 parts by weight, furthermore preferably 0.05 to 5 parts by weight, and most preferably 0.1 to 1 part by weight with respect to 100 parts by weight of the (meth)acrylic polymer. If the addition amount is too small, the effect of preventing bleeding of an antistatic component may be lowered, and on the other hand, if the addition amount is too large, staining with the polyoxyalkylene compound may possibly be caused easily.

### <Acrylic Oligomer>

Further, the pressure-sensitive adhesive composition of the present invention is preferable to contain an acrylic oligomer. Incorporation of the acrylic oligomer is advantageous to give excellent heat resistance, hardly cause blisters and peeling even after heating, and improve the adhesion.

The acrylic oligomer preferably has a weight average molecular weight of 1000 or higher and lower than 30000, more preferably 1500 or higher and lower than 20000, and furthermore preferably 2000 or higher and lower than 10000. If the weight average molecular weight is 30000 or higher, the adhesion is lowered, and if the weight average molecular weight is lower than 1000, the adhesive strength of the surface protective film (pressure-sensitive adhesive sheet) may possibly be lowered because of the low molecular weight, and therefore it is not preferable.

Examples of the acrylic oligomer are (meth)acrylic polymers containing a (meth)acrylic monomer having an alicyclic structure represented by the following formula (2) as a monomer unit, and the acrylic oligomer functions as a tackifier resin, improves the adhesion, and is effective for suppression of blisters of the surface protective film (pressure-sensitive adhesive sheet) in the case of using the acrylic oligomer as an acrylic pressure-sensitive adhesive composition for re-peeling in this embodiment.

CH₂═C(R¹)COOR² (2)

[In the formula (2), R¹ is a hydrogen atom or a methyl group; and R² is an alicyclic hydrocarbon group having an alicyclic structure].

Examples of the alicyclic hydrocarbon group R² in the formula (2) include alicyclic hydrocarbon groups such as a cyclohexyl group, an isobornyl group, and a dicyclopentanyl group. Examples of a (meth)acrylic acid ester having the alicyclic hydrocarbon group include (meth)acrylic acid aliphatic alcohol esters such as cyclohexyl (meth)acrylate containing a cyclohexyl group, isobornyl (meth)acrylate containing an isobornyl group, and dicyclopentanyl (meth)acrylate having a dicyclopentanyl group. Since the acrylic oligomer contains such an acryl-based monomer having a relatively bulky structure as a monomer unit, the adhesion can be improved.

In this embodiment, the alicyclic hydrocarbon group composing the acrylic oligomer preferably has a bridged cyclic structure. The bridged cyclic structure means a tri- or higher alicyclic structure. Since the acrylic oligomer is provided with a bulky structure such as the bridged cyclic structure, the adhesion of the removable acrylic pressure-sensitive adhesive composition (surface protective film, pressure-sensitive adhesive sheet) can be improved more.

Examples of R², which is an alicyclic hydrocarbon group having the bridged cyclic structure, include a dicyclopentanyl group defined by the following formula (3a), a dicyclopentenyl group defined by the following formula (3b), an adamantyl group defined by the following formula (3c), a tricyclopentanyl group defined by the following formula (3d), and a tricyclopentenyl group defined by the following formula (3e). In the case UV polymerization is employed at the time of synthesizing an acrylic oligomer or producing a pressure-sensitive adhesive composition, in terms of scarcity of polymerization inhibition, especially, (meth)acryl-based monomers having a saturated structure such as a dicyclopentanyl group defined by the following formula (3a), an adamantyl group defined by the following formula (3c), and a tricyclopentanyl group defined by the following formula (3d) are preferably used as a monomer composing the acrylic oligomer among these (meth)acryl-based monomer having a tri- or higher alicyclic structure having the bridged cyclic structure.

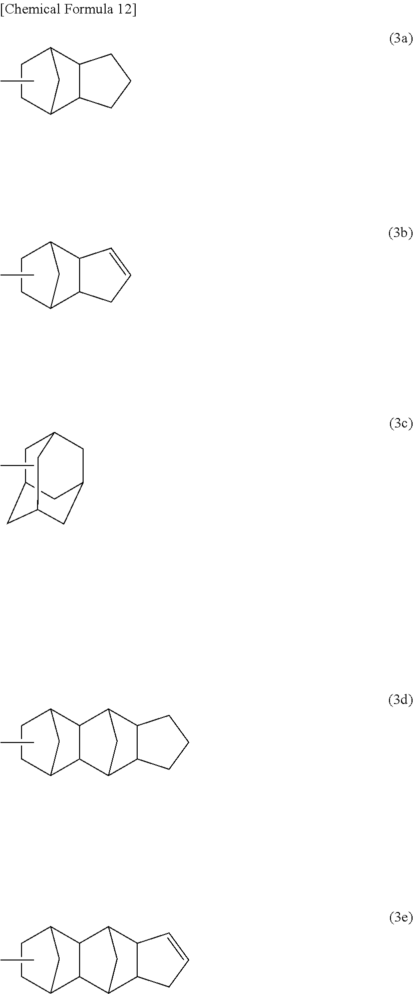

Examples of the (meth)acryl-based monomer having a tri- or higher alicyclic structure having a bridged cyclic structure include (meth)acrylic acid esters such as dicyclopentanyl methacrylate, dicyclopentanyl acrylate, dicyclopentanyloxyethyl methacrylate, dicyclopentanyloxyethyl acrylate, tricyclopentanyl methacrylate, tricyclopentanyl acrylate, 1-adamantyl methacrylate, 1-adamantyl acrylate, 2-methyl-2-adamantyl methacrylate, 2-methyl-2-adamantyl acrylate, 2-ethyl-2-adamantyl methacrylate, and 2-ethyl-2-adamantyl acrylate. These (meth)acryl-based monomers may be used alone or in combination of two or more thereof.

The acrylic oligomer in this embodiment may be a homopolymer of a (meth)acryl-based monomer having an alicyclic structure or a copolymer of a (meth)acryl-based monomer having an alicyclic structure with another (meth)acrylic acid ester monomer or a copolymerizable monomer.

Examples of the (meth)acrylic acid ester monomer include: (meth)acrylic acid alkyl esters such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl(meth)acrylate, hexyl(meth)acrylate, 2-ethylhexyl (meth)acrylate, heptyl (meth)acrylate, octyl (meth)acrylate, isooctyl(meth)acrylate, nonyl(meth)acrylate, isononyl (meth)acrylate, decyl (meth)acrylate, isodecyl (meth)acrylate, undecyl (meth)acrylate, and dodecyl (meth)acrylate; (meth)acrylic acid aryl esters such as phenyl (meth)acrylate and benzyl (meth)acrylate; and (meth)acrylic acid esters derived from terpene compound derivative alcohols. These (meth)acrylic acid esters may be used alone or in combination of two or more thereof.

The acrylic oligomer may be obtained by copolymerization of other monomer components (copolymerizable monomers) copolymerizable with a (meth)acrylic acid ester other than the (meth)acrylic acid ester component units.

Examples of other monomers copolymerizable with a (meth)acrylic acid ester include:

carboxyl group-containing monomers such as acrylic acid, methacrylic acid, carboxyethyl acrylate, carboxypentyl acrylate, itaconic acid, maleic acid, fumaric acid, crotonic acid, and iso-crotonic acid;

alkoxyalkyl (meth)acrylate monomers such as methoxyethyl (meth)acrylate, ethoxyethyl (meth)acrylate, propoxyethyl (meth)acrylate, butoxyethyl (meth)acrylate, and ethoxypropyl (meth)acrylate;

(meth)acrylic acid alkali metal salts;

(poly)alkylene glycol di(meth)acrylic acid ester monomers such as ethylene glycol di(meth)acrylic acid ester, diethylene glycol di(meth)acrylic acid ester, triethylene glycol di(meth)acrylic acid ester, polyethylene glycol di(meth)acrylic acid ester, propylene glycol di(meth)acrylic acid ester, dipropylene glycol di(meth)acrylic acid ester, and tripropylene glycol di(meth)acrylic acid ester;

poly(meth)acrylic acid ester monomers such as trimethylolpropane tri(meth)acrylic acid ester;

vinyl esters such as vinyl acetate and vinyl propionate;

halogenated vinyl compounds such as vinylidene chloride, and 2-chloroethyl (meth)acrylate;

oxazoline group-containing polymerizable compounds such as 2-vinyl-2-oxazoline, 2-vinyl-5-methyl-2-oxazoline, and 2-isopropenyl-2-oxazoline;

aziridine group-containing polymerizable compounds such as (meth)acryloylaziridine and 2-aziridinylethyl (meth)acrylate;

epoxy group-containing vinyl monomers such as allyl glycidyl ether, (meth)acrylic acid glycidyl ether, and 2-ethylglycidyl ether-(meth)acrylate;

hydroxyl group-containing vinyl monomers such as 2-hydroxyethyl(meth)acrylate, 2-hydroxypropyl(meth)acrylate, and adducts of lactones and 2-hydroxyethyl(meth)acrylate;

macromonomers obtained by bonding an unsaturated group such as a (meth)acryloyl group, a styryl group, or a vinyl group to the end of a polyalkylene glycol such as polypropylene glycol, polyethylene glycol, polytetramethylene glycol, polybutylene glycol, polyethylene glycol-polypropylene glycol copolymers, and polybutylene glycol-polyethylene glycol copolymers;

fluorine-containing vinyl monomers such as fluorine-substituted alkyl (meth)acrylic acid alkyl esters;

acid anhydride group-containing monomers such as maleic anhydride and itaconic anhydride;

aromatic vinyl compound monomers such as styrene, α-methylstyrene, and vinyltoluene;

reactive halogen-containing vinyl monomers such as 2-chloroethyl vinyl ether and vinyl monochloroacetate;

amide group-containing vinyl monomers such as (meth)acrylamide, N-isopropyl(meth)acrylamide, N-butyl(meth)acrylamide, N,N-diethyl(meth)acrylamide, N,N-dimethyl(meth)acrylamide, N-methylol(meth)acrylamide, N-ethylol(meth)acrylamide, N-methylolpropane (meth)acrylamide, N-methoxyethyl (meth)acrylamide, N-butoxymethyl(meth)acrylamide, and N-acryloylmorpholine;

succinimide monomers such as N-(meth)acryloyloxymethylenesuccinimide, N-(meth)acryloyl-6-oxyhexamethylenesuccinimide, and N-(meth)acryloyl-8-oxyhexamethylenesuccinimide;

maleimide monomers such as N-cyclohexylmaleimide, N-isopropylmaleimide, N-laurylmaleimide, and N-phenylmaleimide;

itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide;

nitrogen-containing heterocyclic monomers such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinylmorpholine, N-vinylpyrazole, N-vinylisoxazole, N-vinylthiazole, N-vinylisothiazole, and N-vinylpyridazine;

N-vinylcarboxylic acid amides;

lactam monomers such as N-vinylcaprolactam; cyanoacrylate monomers such as (meth)acrylonitrile;

aminoalkyl (meth)acrylate monomers such as aminoethyl (meth)acrylate, N,N-dimethylaminoethyl (meth)acrylate, N,N-dimethylaminoethyl (meth)acrylate, and tert-butylaminoethyl (meth)acrylate;

imide group-containing monomers such as cyclohexylmaleimide and isopropylmaleimide;

isocyanate group-containing monomers such as 2-isocyanatoethyl (meth)acrylate;

organosilicon-containing vinyl monomers such as vinyltrimethoxysilane, γ-methacryloxypropyltrimethoxysilane, allyltrimethoxysilane, trimethoxysilylpropylallylamine, and 2-methoxyethoxytrimethoxysilane;

hydroxyl group-containing monomers such as hydroxyalkyl (meth)acrylates such as hydroxyethyl (meth)acrylate, hydroxypropyl (meth)acrylate, hydroxybutyl (meth)acrylate, hydroxyhexyl (meth)acrylate, hydroxyoctyl (meth)acrylate, hydroxydecyl (meth)acrylate, hydroxylauryl (meth)acrylate, and (4-hydroxymethylcyclohexyl)methyl methacrylate;

acrylic acid ester monomers having a heteroring, a halogen atom, a silicon atom or the like such as tetrahydrofurfuryl (meth)acrylate, fluorine atom-containing (meth)acrylate, and silicone (meth)acrylate;

olefin monomers such as isoprene, butadiene, and isobutylene;

vinyl ether monomers such as methyl vinyl ether and ethyl vinyl ether;

olefins or dienes such as ethylene, butadiene, isoprene, and isobutylene;

vinyl ethers such as vinyl alkyl ether;

vinyl chloride; and

macromonomers having a radical polymerizable vinyl group at the terminal and obtained by polymerizing vinyl monomers. These monomers can be used alone or in combination for copolymerization with the (meth)acrylic acid ester.

Examples of the acrylic oligomer include cyclohexyl methacrylate (CHMA)-isobutyl methacrylate (IBMA) copolymers, cyclohexyl methacrylate (CHMA)-isobornyl methacrylate (IBXMA) copolymers, methyl methacrylate (MMA)-isobornyl methacrylate(IBXMA) copolymers, cyclohexyl methacrylate (CHMA)-acryloylmorpholine (ACMO) copolymers, cyclohexyl methacrylate (CHMA)-diethylacrylamide (DEAA) copolymers, 1-adamantylacrylate(ADA)-methylmethacrylate(MMA)copolymers, dicyclopentanyl methacrylate (DCPMA)-isobornyl methacrylate (IBXMA) copolymers, dicyclopentanyl methacrylate (DCPMA)-methylmethacrylate (MMA) copolymers, dicyclopentanyl methacrylate (DCPMA)-N-vinyl-2-pyrrolidone(NVP) copolymers, dicyclopentanyl methacrylate (DCPMA)-hydroxyethyl methacrylate (HEMA) copolymers, dicyclopentanyl methacrylate (DCPMA)-acrylic acid (AA) copolymers, and homopolymers of dicyclopentanyl methacrylate (DCPMA), cyclohexyl methacrylate (CHMA), isobornyl methacrylate (IBXMA), isobornyl acrylate (IBXA), dicyclopentanyl acrylate (DCPA), 1-adamantyl methacrylate (ADMA), 1-adamantyl acrylate (ADA), and methyl methacrylate (MMA).

Further, a functional group having reactivity on an epoxy group or an isocyanate group may be introduced into the acrylic oligomer. Examples of the functional group include a hydroxyl group, a carboxyl group, an amino group, an amide group, and a mercapto group and a monomer having the functional group may be used (copolymerized) at the time of producing the acrylic oligomer.

In the case the acrylic oligomer is a copolymer of a (meth)acryl-based monomer having an alicyclic structure with another (meth)acrylic acid ester monomer or a copolymerizable monomer, the content of the (meth)acryl-based monomer having an alicyclic structure is preferably 5% by weight or more, more preferably 10% by weight or more, furthermore preferably 20% by weight or more, and even more preferably 30% by weight or more (usually less than 100% by weight and preferably 90% by weight or less) in all the monomers composing the acrylic oligomer. If 5% by weight or more of the (meth)acryl-based monomer having an alicyclic structure is contained, the adhesion can be improved without lowering the transparency.

The pressure-sensitive adhesive composition of the present invention may properly contain other known additives, for example, powders such as a coloring agent and a pigment, a surfactant, a plasticizer, a tackifier, a low-molecular weight polymer, a surface lubricant, a leveling agent, an antioxidant, a corrosion preventing agent, a photostabilizer, an ultraviolet absorbing agent, a polymerization inhibitor, a silane coupling agent, an inorganic or organic filler, a metal powder, granules, foils and others, depending on utility.

### <Surface Protective Film for Acrylic Film Protection>

The surface protective film for acrylic film protection of the present invention preferably has a support film and a pressure-sensitive adhesive layer formed by crosslinking the pressure-sensitive adhesive composition on at least one surface of the support film. It is general to carry out crosslinking of the pressure-sensitive adhesive composition after application of the pressure-sensitive adhesive composition, and it is also possible to transfer a pressure-sensitive adhesive layer of the pressure-sensitive adhesive composition after crosslinking to a support film.

The method for forming the pressure-sensitive adhesive layer on the support film is not particularly limited, and for example, the pressure-sensitive adhesive layer is formed on the support film by a process including applying the pressure-sensitive adhesive composition to the support film, and removing the polymerization solvent or the like by drying. Thereafter, curing may be performed to control the migration of the components in the pressure-sensitive adhesive layer or to control the crosslinking reaction. Further, in the case of forming the surface protective film by applying the pressure-sensitive adhesive composition to the support film, one or more kinds of solvents other than the polymerization solvent may be newly added to the pressure-sensitive adhesive composition so that the composition can be uniformly applied to the support film.

As the method for forming the pressure-sensitive adhesive layer at the time of producing the surface protective film for acrylic film protection of the present invention, known methods used for producing pressure-sensitive adhesive tapes may be employed. Specifically, examples include roll coating, gravure coating, reverse coating, roll blush, spray coating, air knife coating, and extrusion coating using a die coater.

The surface protective film for acrylic film protection of the present invention is formed in such a manner that the thickness of the pressure-sensitive adhesive layer is adjusted to 3 to 100 μm, and preferably about 5 to 50 μm. If the thickness of the pressure-sensitive adhesive layer is within the range, good balance between proper removability and adhesion can be obtained, and therefore it is preferable. The surface protective film is obtained by applying the pressure-sensitive adhesive composition to one or both surfaces of various support films made of plastic films such as polyester films or porous materials such as paper and nonwoven fabrics to form the pressure-sensitive adhesive layer, and the resultant is formed into a sheet-like shape, a tape-like shape, etc.

The support film constituting the surface protective film of the prevent invention usually has a thickness of 5 to 200 μm and preferably about 10 to 100 μm. If the thickness of the support film is within the range, the bonding workability to an adherend and the peeling workability from an adherend are excellent, and therefore it is preferable.

The support film may be subjected to releasing, or anti-staining treatment with silicone, fluorine, long chain alkyl-based or fatty acid amide-based releasing agent, or a silica powder, easy adhesion treatment such as acid treatment, alkali treatment, primer treatment, corona treatment, plasma treatment, and ultraviolet ray treatment, or antistatic treatment such as coating type, kneading type, or deposition type antistatic treatment, if necessary.

The surface protective film (including pressure-sensitive adhesive sheet) of the present invention has the pressure-sensitive adhesive layer formed on at least one surface of the support film, and the support film is preferably a plastic film treated with an antistatic treatment. Use of the support film can suppress electrification of the surface protective film itself at the time of peeling, and therefore it is preferable. Since being provided with the pressure-sensitive adhesive layer (using antistatic agent or the like) formed by crosslinking the pressure-sensitive adhesive composition having the above-mentioned effect, the surface protective film prevents electrification of an object to be protected, which is not subjected to an antistatic treatment, at the time of peeling and less stains the object to be protected. Therefore, the surface protective film is very useful as an antistatic surface protective film in the technical fields related to optical and electronic components where electrification and staining are particularly serious problems. When the support film is a plastic film and the plastic film is subjected to an antistatic treatment, those which lowers electrification of the surface protective film itself and are excellent in antistatic performance for the object to be protected can be obtained.

The support film is preferably a plastic film having heat resistance, solvent resistance, and flexibility. When the support film has flexibility, the pressure-sensitive adhesive composition can be applied using a roll coater or the like, and the product can be wound into a roll.

The plastic film is not particularly limited as far as it can be formed into a sheet or a film, and examples include a polyolefin film such as polyethylene, polypropylene, poly-1-butene, poly-4-methyl-1-pentene, an ethylene.propylene copolymer, an ethylene.1-butene copolymer, an ethylene.vinyl acetate copolymer, an ethylene.ethyl acrylate copolymer, and an ethylene.vinyl alcohol copolymer, a polyester film such as polyethylene terephthalate, polyethylene naphthalate, and polybutylene terephthalate, a polyacrylate film, a polystyrene film, a polyamide film such as nylon 6, nylon 6,6, and partially aromatic polyamide, a polyvinyl chloride film, a polyvinylidene chloride film, and a polycarbonate film.

In the present invention, an antistatic treatment which is performed on the plastic film is not particularly limited, but for example, a method of providing an antistatic layer on at least one side of a generally used substrate, or a method of kneading a kneading-type antistatic agent into a plastic film is used. Examples of a method of providing an antistatic layer on at least one side of a substrate include a method of coating an antistatic resin comprising an antistatic agent and a resin component, or an electrically conductive resin containing an electrically conductive polymer or an electrically conductive substance, and a method of depositing or plating an electrically conductive substance.

Examples of an antistatic agent contained in an antistatic resin include a cation-type antistatic agent having a cationic functional group such as a quaternary ammonium salt, a pyridinium salt, and a primary, secondary or tertiary amino group, an anion-type antistatic agent having an anionic functional group such as a sulfonic acid salt, a sulfuric acid ester salt, a phosphonic acid salt, and a phosphoric ester salt, an amphoteric-type antistatic agent such as alkylbetain and a derivative thereof, imidazoline and a derivative thereof, and alanine and a derivative thereof, a non ion-type antistatic agent such as glycerin and a derivative thereof, and polyethylene glycol and a derivative thereof, and an ionic electrically conductive polymer obtained by polymerizing or copolymerizing a monomer having the aforementioned cation-type, anion-type, or amphoteric-type ionic electrically conductive group. These compounds may be used alone, or two or more of them may be used by mixing.

Specifically, examples of the cation-type antistatic agent include a (meth)acrylate copolymer having a quaternary ammonium group such as an alkyl trimethylammmonium salt, acyloylamidopropyltrimethtylammonium methosulfate, an alkylbenzylmethylammonium salt, acyl choline chloride, and polydimethylaminoethyl methacrylate, a styrene copolymer having a quaternary ammonium group such as polyvinylbenzyltrimethylammonium chloride, and a diallylamine copolymer having a quaternary ammonium group such as polydiallyldimethylammonium chloride. The compounds may be used alone, or two or more kinds may be used by mixing.

Examples of the anion-type antistatic agent include an alkyl sulfonic acid salt, an alkylbenzenesulfonic acid salt, an alkyl sulfate ester salt, an alkyl ethoxy sulfate ester salt, an alkyl phosphate ester salt, and a sulfonic acid group-containing styrene copolymer. These compounds may be used alone, or two or more kinds may be used by mixing.

Examples of the amphoteric-type antistatic agent include alkylbetain, alkylimidazoliumbetain, and carbobetaingrafted copolymer. These compounds may be used alone, or two or more kinds may be used by mixing.

Examples of the non ion-type antistatic agent include fatty acid alkylolamide, di(2-hydroxyethyl)alkylamine, polyoxyethylenealkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylenediamine, a copolymer consisting of polyether, polyester and polyamide, and methoxypolyethyleneglycol (meth)acrylate. These compounds may be used alone, or two or more kinds may be used by mixing.

Examples of the electrically conductive polymer include polyaniline, polypyrrole and polythiophene. These compounds may be used alone, or two or more kinds may be used by mixing.

Examples of the electrically conductive substance include tin oxide, antimony oxide, indium oxide, cadmium oxide, titanium oxide, zinc oxide, indium, tin, antimony, gold, silver, copper, aluminum, nickel, chromium, titanium, iron, covert, copper iodide, and an alloy and a mixture thereof.

As a resin component used in the antistatic resin and the electrically conductive resin, a generally used resin such as polyester, acryl, polyvinyl, urethane, melanine and epoxy is used. In the case of a polymer-type antistatic agent, it is not necessary that a resin component is contained. In addition, the antistatic resin component may contain compounds of a methylolated or alkylolated melanine series, a urea series, a glyoxal series, and an acrylamide series, an epoxy compound, or an isocyanate compound as a crosslinking agent.

An antistatic layer is formed, for example, by diluting the aforementioned antistatic resin, electrically conductive polymer or electrically conductive resin with a solvent such as an organic solvent and water, and coating this coating solution on a plastic film, followed by drying.

Examples of an organic solvent used in formation of the antistatic layer include methyl ethyl ketone, acetone, ethyl acetate, tetrahydrofuran, dioxane, cyclohexanone, n-hexane, toluene, xylene, methanol, ethanol, n-propanol and isopropanol. These solvents may be used alone, or two or more kinds may be used by mixing.

As a coating method in formation of the antistatic layer, the known coating method is appropriately used, and examples include roll coating, gravure coating, reverse coating, roll brushing, spray coating, and air knife coating methods, an immersing and curtain coating method.

A thickness of the aforementioned antistatic resin layer, electrically conductive polymer or electrically conductive resin is usually 0.001 to 5 μm, preferably around 0.03 to 1 μm. Within the above range, the plastic film is less likely to degrade in heat resistance, solvent resistance and flexibility, which is preferred.

Examples of a method of depositing or plating an electrically conductive substance include vacuum deposition, sputtering, ion plating, chemical deposition, spray pyrolysis, chemical plating, and electric plating methods.

The thickness of the electrically-conductive material layer is generally from 0.002 to 1 μm, preferably from 0.005 to 0.5 μm. Within the above range, the plastic film is less likely to degrade in heat resistance, solvent resistance and flexibility, which is preferred.

As the kneading-type antistatic agent, the aforementioned antistatic agent is appropriately used. The amount of the kneading-type antistatic agent to be blended is 20% by weight or less, preferably in a range of 0.05 to 10% by weight, based on the total weight of a plastic film. Within the above range, the plastic film is less likely to degrade in heat resistance, solvent resistance and flexibility, which is preferred. A kneading method is not particularly limited as far as it is a method by which the antistatic agent can be uniformly mixed into a resin used in a plastic film, but for example, a heating roll, a Banbury mixer, a pressure kneader, and a biaxial kneading machine are used.

If necessary, a separator can be bonded to the pressure-sensitive adhesive layer surface of the surface protective film (including pressure-sensitive adhesive tape, etc.) of the present invention for the purpose of protecting the pressure-sensitive adhesive surface.

The material used to form the separator may be paper or a plastic film. The plastic film is preferably used because of its good surface smoothness. Such a film may be of any type capable of protecting the pressure-sensitive adhesive layer, and examples thereof include apolyethylene film, apolypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film and the like.

The separator generally has a thickness of about 5 to 200 μm, and preferably about 10 to 100 μm. Within the above range, good workability can be obtained in bonding to the pressure-sensitive adhesive layer and in peeling from the pressure-sensitive adhesive layer, which is preferred. If necessary, the separator may be subjected to release and antifouling treatment with a silicone, fluoride, long-chain alkyl, or fatty acid amide release agent or silica powder or subjected to anti static treatment of coating type, kneading type, vapor-deposition type, or the like.

The surface protective film of the present invention has an adhesive strength (A) of 0.12 N/25 mm or lower, preferably 0.10 N/25 mm or lower, more preferably 0.08 N/25 mm or lower, and most preferably 0.06 N/25 mm or lower at a peel rate of 0.3 m/min after the pressure-sensitive adhesive surface of the pressure-sensitive adhesive layer formed by crosslinking the pressure-sensitive adhesive composition is attached to an acrylic film at 23° C. for 30 minutes. If the adhesive strength exceeds 0.12N/25 mm, the peeling workability becomes inferior, and therefore it is not preferable.

The surface protective film of the present invention has an adhesive strength (B) of 0.14 N/25 mm or lower, preferably 0.12 N/25 mm or lower, more preferably 0.10 N/25 mm or lower, and most preferably 0.08 N/25 mm or lower at a peel rate of 0.3 m/min after the pressure-sensitive adhesive surface of the pressure-sensitive adhesive layer formed by crosslinking the pressure-sensitive adhesive composition is attached to an acrylic film at 60° C. for one week. If the adhesive strength exceeds 0.14N/25 mm, the peeling workability becomes inferior, and therefore it is not preferable.

The surface protective film of the present invention has an adhesive strength ratio (B/A) of the adhesive strength (A) at a peel rate of 0.3 m/min after the pressure-sensitive adhesive surface of the pressure-sensitive adhesive layer formed by crosslinking the pressure-sensitive adhesive composition is attached to an acrylic film at 23° C. for 30 minutes and the adhesive strength (B) at a peel rate of 0.3 m/min after the pressure-sensitive adhesive surface of the pressure-sensitive adhesive layer formed by crosslinking the pressure-sensitive adhesive composition is attached to an acrylic film, at 60° C. for one week of 2.8 or lower, preferably 2.6 or lower, and more preferably 2.5 or lower. If the adhesive strength ratio exceeds 2.8, an increase in adhesive strength after heating is observed and a problem for practical use is caused, and therefore it is not preferable.

In the surface protective film of the present invention, the potential (peeling electrification voltage: kV, absolute value) of the surface of an acrylic film (for example in the case where an adherend is a polarizing plate and the protective layer constituting the polarizing plate is an acrylic resin, the acrylic resin is regarded as an acrylic film) generated at the time of peeling the pressure-sensitive adhesive layer used for the surface protective film from the acrylic film at 23° C. and 50% RH, a peeling angle of 150°, and a peel rate of 30 m/min (high speed peeling) is preferably 1.5 kV or lower, more preferably 1.2 kV or lower, and furthermore preferably 1.0 kV or lower. If the peeling electrification voltage exceeds 1.5 kV, for example, a liquid crystal driver or the like may possibly be damaged, and therefore it is not preferable.

### <Optical Member>

The optical member of the present invention is preferably protected with the surface protective film for acrylic film protection. Since the surface protective film has proper adhesive strength so as not to cause blisters and peeling over time and is excellent in removability and workability, it is usable for surface protection at the time of processing, transporting, shipping, etc., and therefore the surface protective film is useful for protecting the surface (acrylic film surface) of the optical member (adherend using acrylic resin: acrylic film). In particular, the surface protective film can be used for plastic products produced from acrylic resins in which static electricity is generated easily, and is therefore very useful for preventing electrification in the technical fields related to optical and electronic components where electrification becomes a serious problem.

### EXAMPLES

Hereinafter, the features and effects of the present invention will be more specifically described with reference to examples and the like, which however are not intended to limit the invention. The evaluation items in the examples and the like were measured as described below. In addition, “part by weight” may be expressed as “part”.

### <Measurement of Weight Average Molecular Weight (Mw)>

A weight average molecular weight (Mw) was measured using a GPC apparatus (HLC-8220GPC manufactured by Tosoh Corporation). Measuring conditions are as follows.

Sample concentration: 0.2 wt % (THF solution)

Sample injection amount: 10 μl

Eluent: THF

Flow rate: 0.6 ml/min

Measuring temperature: 40° C.

Column:

Sample column;

TSKguard column SuperHZ-H (1 column)+TSK gel Super HZM-H (2 columns)

Reference column;

TSK gel SuperH-RC(1 column)

Detector: Refractive index detector (RI)

A molecular weight was obtained in terms of polystyrene.

### <Theoretical Value of Glass Transition Temperature>

A glass transition temperature (Tg) (° C.) was determined by the following equation using the following reference values as a glass transition temperature Tgn (° C.) of a homopolymer of each monomer.

1/(Tg+273)=Σ[Wn/(Tgn+273)] Equation:

[where Tg (° C.) represents a glass transition temperature of a copolymer, Wn (−) represents a weight fraction of each monomer, Tgn (° C.) represents a glass transition temperature of a homopolymer of each monomer, and n represents a kind of each monomer]
Reference values:

2-Ethylhexyl acrylate (2EHA): −70° C.

4-Hydroxybutyl acrylate (4HBA): −32° C.

Acrylic acid (AA): 106° C.

2-Hydroxyethyl acrylate (HEA): −15° C.

Dicyclopentanyl methacrylate (DCPMA): 175° C.

Methyl methacrylate (MMA): 105° C.

For the literature values, reference was made to “Synthesis/Design of Acrylic Resins and Development of New Applications” (published by Publishing Department of Chuo Keiei Kaihatsu Center) and “Polymer Handbook” (John Wiley & Sons).

### <Measurement of Glass Transition Temperature>

A glass transition temperature (Tg) (° C.) was determined by the method described below using a dynamic viscoelasticity measurement system (ARES manufactured by Rheometric Scientific Inc.).

Sheets of a (meth)acryl-based polymer having a thickness of 20 μm were laminated into a thickness of about 2 mm, and this was punched into φ7.9 mm to prepare a cylindrical pellet, and this was used as a sample for measuring a glass transition temperature.

The measuring sample was fixed on a jig of a φ7.9 mm parallel plate and temperature dependency of loss elastic modulus G″ was measured using the dynamic viscoelasticity measuring apparatus, and a temperature at which the resulting G″ curve became a maximum was adopted as a glass transition temperature (° C.).

Measuring conditions are as follows.

Measurement: shear mode

Temperature range: −70° C. to 150° C.

Temperature raising rate: 5° C./min

Frequency: 1 Hz

### <Production Example of Acrylic Film>

### (Production of Resin Composition)

A resin was produced by using a tandem type reaction extruder including two extrusion reactors arranged in series.

Regarding the tandem type reaction extruder, an equi-directional meshing type biaxial extruder with a diameter of 75 mm and a L/D (the ratio of length L and diameter D of the extruder) of 74 was used for both of a first extruder and a second extruder, and a raw material resin was supplied to the raw material supply port of the first extruder by using a quantitative feeder (manufactured by Kubota Corporation). The degree of pressure reduction of the respective vents in the first extruder and the second extruder was adjusted to −0.095 MPa. Further, the first extruder and the second extruder were connected with a pipe with a diameter of 38 mm and a length of 2 m, and a constant flow pressure valve was used for an inner pressure control mechanism for a part connecting the resin discharge port of the first extruder and the raw material supply port of the second extruder. The resin (strands) discharged out of the second extruder was cooled by a cooling conveyer and thereafter cut by a pelletizer to obtain pellets. Herein, for adjusting the inner pressure for the part connecting the resin discharge port of the first extruder and the raw material supply port of the second extruder or observing the extrusion change, a resin pressure meter is installed in the first extruder outlet, the center part of the connection part of the first extruder and the second extruder, and the second extruder outlet.

Regarding the first extruder, a polymethyl methacrylate resin (Mw: 105000) was used as a raw material resin and monomethylamine was used as an imidizing agent to produce an imide resin intermediate 1. At this time, the temperature in the highest temperature part of the extruder was 280° C., the screw rotation speed was 55 rpm, the raw material resin supply amount was 150 kg/h, and the addition amount of monomethylamine was 2.0 parts by weight with respect to 100 parts by weight of the raw material resin. Further, the constant flow pressure valve was installed immediately before the raw material supply port of the second extruder to adjust the pressure of the monomethylamine pressure-injection part of the first extruder to 8 MPa.

Successively, the imide intermediate 1 was supplied to the second extruder, and the remaining imidization reaction reagent and byproducts were devolatilized by a rear vent and a vacuum vent, and a mixed solution of dimethyl carbonate and triethylamine was then added as an esterification agent to produce an imide resin intermediate 2. At this time, the respective barrel temperature of the extruder was controlled to be 260° C., the screw rotation speed was 55 rpm, the addition amount of dimethyl carbonate was 3.2 parts by weight with respect to 100 parts by weight of the raw material resin, and the addition amount of triethylamine was 0.8 parts by weight with respect to 100 parts by weight of the raw material resin. After the esterification agent was removed by the vent, the imide intermediate 2 was extruded out of a strand die, cooled in a water tank, and pelletized by a pelletizer to obtain a resin composition. The imidization ratio of this resin composition was 3.7% and the acid value was 0.29 mmol/g.

### (Production of Acrylic Film)

Resin pellets were produced by mixing 100 parts by weight of the resin composition and 0.62 parts by weight of a triazine type ultraviolet absorbent (manufactured by ADEKA, trade name: T-712) at 220° C. by a biaxial kneader. The obtained pellets were dried at 100.5 kPa and 100° C. for 12 hours and formed into a film-like shape (thickness 160 μm) by extrusion with a T die of a monoaxial kneader at a die temperature of 270° C.

The film was further stretched in the transportation direction in 150° C. atmosphere (thickness 80 μm) and successively stretched in the direction orthogonal to the film transportation direction in 150° C. atmosphere to obtain an acrylic film (acrylic resin film) with a thickness of 40 μm.

The obtained acrylic film (acrylic resin film) had a light transmittance of light having a wavelength of 380 nm of 8.5%, an in-plane retardation Re of 0.4 nm, a retardation in thickness direction Rth of 0.78 nm. The obtained acrylic film (acrylic resin film) had a moisture permeability of 61 g/m²·24 hr.

The light transmittance was determined by measuring the transmittance spectra in a wavelength range of 200 nm to 800 nm with a spectrophotometer (apparatus name: U-4100) manufactured by Hitachi High-Technologies Corporation, and reading the transmittance at a wavelength of 380 nm. The retardation value was measured using trade name “KOBRA 21-ADH” manufactured by Oji Scientific Instruments at 23° C. and a wavelength of 590 nm. The moisture permeability was measured by a method in accordance with JIS K 0208 in the conditions of a temperature of 40° C. and a relative humidity of 92%.

### <Measurement of Peeling Electrification Voltage>

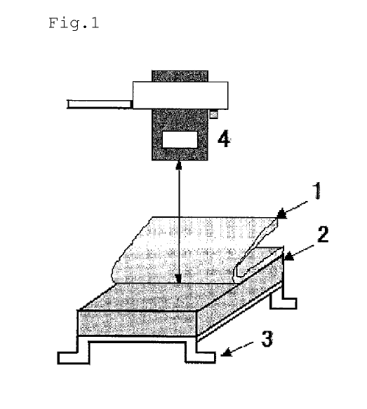

A produced surface protective film (pressure-sensitive adhesive sheet) was cut into a piece in a size of 70 mm in width and 130 mm in length and the separator was peeled off, the piece was then attached to the acrylic film (thickness: 40 μm, width: 70 mm, length: 100 mm) which had been previously destaticized and press-bonded to the acrylic film surface by a hand roller in such a manner that one end of the piece protruded 30 mm out of the film. Successively, the resulting sample was allowed to stand in an environment at 23° C. and 50±2% RH for one day and then set at a prescribed position as shown in FIG. 1. The one end protruding 30 mm was fixed to an automatic winder, and the piece was peeled off at a peeling angle of 150° and a peel rate of 30 m/min. The potential generated on the surface of the acrylic film surface in this process was measured using a potentiometer (KSD-0103, manufactured by KASUGA ELECTRIC WORKS LTD.) fixed at a prescribed position. The distance between the sample and the potentiometer was adjusted to 100 mm.

### <Measurement of Initial Adhesive Strength (23° C.×30 Min)>

After the acrylic film (width: 70 mm, length: 100 mm) was allowed to stand in an environment at 23° C. and 50% RH for 30 minutes, a surface protective film cut in a size of 25 mm in width and 100 mm in length was laminated on the acrylic film at a pressure of 0.25 MPa and a rate of 0.3 m/min to produce an evaluation sample.

After the lamination, the sample was allowed to stand in an environment at 23° C. and 50% RH for 30 minutes, and the initial adhesive strength (N/25 mm) was measured using a universal tensile tester at the time of peeling off the sheet at a peel rate of 0.3 m/min (low-speed peeling) and a peeling angle of 180°. The measurement was performed in an environment at 23° C. and 50% RH.

<Measurement of Adhesive Strength after Heating (60° C.×One Week)>

After the acrylic film (width: 70 mm, length: 100 mm) was allowed to stand in an environment at 23° C. and 50% RH for 30 minutes, a surface protective film cut in a size of 25 mm in width and 100 mm in length was laminated on the acrylic film at a pressure of 0.25 MPa and a rate of 0.3 m/min to produce an evaluation sample.

After the lamination, the sample was allowed to stand in an environment at 60° C. for one week, and the adhesive strength (N/25 mm) was measured using a universal tensile tester at the time of peeling off the sheet at a peel rate of 0.3 m/min (low-speed peeling) and a peeling angle of 180°. The measurement was performed in an environment at 23° C. and 50% RH.

### [Preparation of (Meth)Acrylic Polymer (A)]

A four-neck flask equipped with a stirring blade, a thermometer, a nitrogen gas introduction tube, and a condenser was charged with 100 parts by weight of 2-ethylhexyl acrylate(2EHA), 10 parts by weight of 4-hydroxybutyl acrylate (4HBA), 0.02 parts by weight of acrylic acid (AA), 0.2 parts by weight of 2,2′-azobisisobutyronitrile as a polymerization initiator, and 157 parts by weight of ethyl acetate, and nitrogen gas was introduced under a mildly stirring condition, and then a polymerization reaction was performed for six hours while the liquid temperature in the flask was kept at about 65° C. to prepare a (meth)acrylic polymer (A) solution (40 wt %). This acrylic polymer (A) had a weight average molecular weight of 540000 and a glass transition temperature (Tg) of −67° C.

### [Preparation of (Meth)Acrylic Polymer (B)]

A four-neck flask equipped with a stirring blade, a thermometer, a nitrogen gas introduction tube, and a condenser was charged with 100 parts by weight of 2-ethylhexyl acrylate(2EHA), 4 parts by weight of 2-hydroxyethyl acrylate (HEA), 0.2 parts by weight of 2,2′-azobisisobutyronitrile as a polymerization initiator, and 157 parts by weight of ethyl acetate, and nitrogen gas was introduced under a mildly stirring condition, and then a polymerization reaction was performed for six hours while the liquid temperature in the flask was kept at about 65° C. to prepare a (meth)acrylic polymer (B) solution (40 wt %). This acrylic polymer (B) had a weight average molecular weight of 540000 and a glass transition temperature (Tg) of −68° C.

### Example 1

### Preparation of Pressure-Sensitive Adhesive Solution

The (meth)acrylic polymer (A) solution (40 wt %) was diluted to 20% by weight with ethyl acetate, and 500 parts by weight (100 parts by weight of solid matter) of the obtained solution was added with 2 parts by weight of a solution (0.2 parts by weight of solid matter) obtained by diluting an organopolysiloxane having oxyalkylene chains (KF-353, manufactured by Shin-Etsu Chemical Co., Ltd.) to 10% with ethyl acetate as a silicone component; 15 parts by weight of a solution (0.15 parts by weight of solid matter) obtained by diluting lithium bis(trifluoromethanesulfonyl)imide (LiN(CF₃SO₂)₂:LiTFSI, manufactured by Tokyo Kasei Kogyo Co., Ltd.) to 1% with ethyl acetate as an alkali metal salt (ionic compound), that is, an antistatic agent; 1.75 parts by weight (1.75 parts by weight of solid matter) of an isocyanurate of hexamethylenediisocyanate (COLONATE HX, manufactured by Nippon Polyurethane Industry Co., Ltd.) as a tri-functional isocyanate compound; 0.3 parts by weight (0.3 parts by weight of solidmatter) of 1,3-bis(isocyanatomethyl)cyclohexane (TAKENATE 600 (manufactured by Mitsui Chemicals, Inc.) as a di-functional isocyanate compound; and 2 parts by weight (0.02 parts by weight of solid matter) of dibutyltin dilaurate (1 wt % ethyl acetate solution) as a crosslinking catalyst, followed by mixing and stirring to obtain an acrylic pressure-sensitive adhesive solution.

### [Production of Antistatic-Treated Film]

An antistatic agent solution was prepared by diluting 10 parts by weight of an antistatic agent (Micro-Solver RMd-142, manufactured by Solvex, which contains tin oxide and polyester resin as main components) with a solvent mixture containing 30 parts by weight of water and 70 parts by weight of methanol.

The obtained antistatic agent solution was applied to a polyethylene terephthalate (PET) film (thickness: 38 μm) by a Meyer bar and dried at 130° C. for 1 minute to remove the solvent so that an antistatic layer (thickness: 0.2 μm) was formed and then an antistatic-treated film was produced.

### [Production of Surface Protective Film (Pressure-Sensitive Adhesive Sheet)]

The acrylic pressure-sensitive adhesive solution was applied to the surface opposite to the antistatic-treated surface of the antistatic-treated film, and heated at 130° C. for 2 minutes to form a 15 μm thick pressure-sensitive adhesive layer. Next, a polyethylene terephthalate film (thickness: 25 μm) with one surface treated with silicone was provided, and the silicone-treated surface of the polyethylene terephthalate film was attached to the surface of the pressure-sensitive adhesive layer to produce a surface protective film (pressure-sensitive adhesive sheet).

The oligomer in Tables 3 and 4 refers to an acrylic oligomer, and was prepared according to the following methods to be used.

### [Preparation of Acrylic Oligomer]

A four-neck flask equipped with a stirring blade, a thermometer, a nitrogen gas introduction tube, a condenser, and a dropping funnel was charged with 100 parts by weight of toluene, 60 parts by weight of dicyclopentanyl methacrylate (DCPMA) (trade name: FA-513M, manufactured by Hitachi Chemical Co., Ltd.), 40 parts by weight of methyl methacrylate (MMA), and 3.5 parts by weight of methyl thioglycolate as a chain transfer agent. After the mixture was stirred at 70° C. for one hour in a nitrogen environment, 0.2 parts by weight of 2,2′-azobisisobutyronitrile as a polymerization initiator was added, and then reaction was performed at 70° C. for two hours and successively at 80° C. for four hours and further at 90° C. for one hour to obtain an acrylic oligomer. This acrylic oligomer had a weight average molecular weight of 4000 and a glass transition temperature (Tg) of 144° C.

### Examples 2 to 22, and Comparative Examples 1 to 6

Surface protective films (pressure-sensitive sheets) were produced in the same manner as in Example 1 based on the mixing ratios shown in Tables 1 to 4. In addition, the mixing amounts in Tables 1 to 4 were shown by solid matter. In Example 8 and Comparative Example 5, the (meth)acrylic polymer (B) was used in place of the (meth)acrylic polymer (A) used in Example 1.

According to the above-mentioned methods, the low-speed adhesive strength (in initial period, after heating 60° C.×one week) of each surface protective film to the acrylic film (resin), the adhesive strength ratio, and the measurement and evaluation of the peeling electrification voltage to the acrylic film (resin) were measured. The obtained results are shown in Tables 5 and 6.

TABLE 1

| | (Meth)acrylic polymer | | | | | | |
|---|---|---|---|---|---|---|---|
| | (Meth)acrylic | | | | | | |
| | monomer | | | | | | |
| | having alkyl | | | | | | |
| | group of 1 to 14 | | Hydroxyl | | Carboxyl | | |
| | carbon atoms | | group-containing | | group-containing | | |
| Preparation of | | Addition | (meth)acrylic monomer | | (meth)acrylic monomer | | |
| polymer | Type | amount | Type | Addition amount | Type | Addition amount | Polymer |
| Example 1 | 2EHA | 100 parts | 4HBA | 10 parts | AA | 0.02 parts | (A) |
| Example 2 | 2EHA | 100 parts | 4HBA | 10 parts | AA | 0.02 parts | (A) |
| Example 3 | 2EHA | 100 parts | 4HBA | 10 parts | AA | 0.02 parts | (A) |
| Example 4 | 2EHA | 100 parts | 4HBA | 10 parts | AA | 0.02 parts | (A) |
| Example 5 | 2EHA | 100 parts | 4HBA | 10 parts | AA | 0.02 parts | (A) |
| Example 6 | 2EHA | 100 parts | 4HBA | 10 parts | AA | 0.02 parts | (A) |
| Example 7 | 2EHA | 100 parts | 4HBA | 10 parts | AA | 0.02 parts | (A) |
| Example 8 | 2EHA | 100 parts | HEA | 4 parts | — | — | (B) |
| Comparative | 2EHA | 100 parts | 4HBA | 10 parts | AA | 0.02 parts | (A) |
| Example 1 | | | | | | | |
| Comparative | 2EHA | 100 parts | 4HBA | 10 parts | AA | 0.02 parts | (A) |
| Example 2 | | | | | | | |
| Comparative | 2EHA | 100 parts | 4HBA | 10 parts | AA | 0.02 parts | (A) |
| Example 3 | | | | | | | |
| Comparative | 2EHA | 100 parts | 4HBA | 10 parts | AA | 0.02 parts | (A) |
| Example 4 | | | | | | | |
| Comparative | 2EHA | 100 parts | HEA | 4 parts | — | — | (B) |
| Example 5 | | | | | | | |
| Comparative | 2EHA | 100 parts | 4HBA | 10 parts | AA | 0.02 parts | (A) |
| Example 6 | | | | | | | |

TABLE 2

| | (Meth)acrylic polymer | | | | | | |
|---|---|---|---|---|---|---|---|
| | (Meth)acrylic | | | | | | |
| | monomer | | | | | | |
| | having alkyl | | | | | | |
| | group of 1 to 14 | | Hydroxyl | | Carboxyl | | |
| | carbon atoms | | group-containing | | group-containing | | |
| Preparation of | | Addition | (meth)acrylic monomer | | (meth)acrylic monomer | | |
| polymer | Type | amount | Type | Addition amount | Type | Addition amount | Polymer |
| Example 9 | 2EHA | 100 parts | 4HBA | 10 parts | AA | 0.02 parts | (A) |
| Example 10 | 2EHA | 100 parts | 4HBA | 10 parts | AA | 0.02 parts | (A) |
| Example 11 | 2EHA | 100 parts | 4HBA | 10 parts | AA | 0.02 parts | (A) |
| Example 12 | 2EHA | 100 parts | 4HBA | 10 parts | AA | 0.02 parts | (A) |
| Example 13 | 2EHA | 100 parts | 4HBA | 10 parts | AA | 0.02 parts | (A) |
| Example 14 | 2EHA | 100 parts | 4HBA | 10 parts | AA | 0.02 parts | (A) |
| Example 15 | 2EHA | 100 parts | 4HBA | 10 parts | AA | 0.02 parts | (A) |
| Example 16 | 2EHA | 100 parts | 4HBA | 10 parts | AA | 0.02 parts | (A) |
| Example 17 | 2EHA | 100 parts | 4HBA | 10 parts | AA | 0.02 parts | (A) |
| Example 18 | 2EHA | 100 parts | 4HBA | 10 parts | AA | 0.02 parts | (A) |
| Example 19 | 2EHA | 100 parts | 4HBA | 10 parts | AA | 0.02 parts | (A) |
| Example 20 | 2EHA | 100 parts | 4HBA | 10 parts | AA | 0.02 parts | (A) |
| Example 21 | 2EHA | 100 parts | 4HBA | 10 parts | AA | 0.02 parts | (A) |
| Example 22 | 2EHA | 100 parts | 4HBA | 10 parts | AA | 0.02 parts | (A) |

The abbreviations in Table 1 and Table 2 will be described below.

2EHA: 2-ethylhexyl acrylate
HEA: 2-hydroxyethyl acrylate
4HBA: 4-hydroxybutyl acrylate
AA: acrylic acid

TABLE 3

| | | Crosslinking agent | | | | | | | | |
|---|---|---|---|---|---|---|---|---|---|---|
| Pressure- | | Tri-functional | | | | Silicone | | | | |
| sensitive | | NCO | | Bi-functional NCO | | component | | Antistatic agent | | Oligomer |
| adhesive | | | Addition | | Addition | | Addition | | Addition | Addition |
| composition | Polymer | Type | amount | Type | amount | Type | amount | Type | amount | amount |
| Example 1 | 100 parts | C/HX | 1.75 parts | TAKENATE 600 | 0.3 parts | KF353 | 0.2 parts | LiTFSI | 0.15 parts | — |
| Example 2 | 100 parts | C/HX | 1.75 parts | TAKENATE 600 | 1 part | KF353 | 0.2 parts | LiTFSI | 0.15 parts | — |
| Example 3 | 100 parts | C/HX | 3.5 parts | TAKENATE 600 | 0.3 parts | KF353 | 0.2 parts | LiTFSI | 0.15 parts | — |
| Example 4 | 100 parts | C/HX | 3.5 parts | TAKENATE 600 | 1 part | KF353 | 0.2 parts | LiTFSI | 0.15 parts | — |
| Example 5 | 100 parts | C/HX | 3.5 parts | TAKENATE 600 | 0.3 parts | KF353 | 0.2 parts | LiTFSI | 0.15 parts | 0.5 parts |
| Example 6 | 100 parts | C/HX | 3.5 parts | TAKENATE 500 | 0.3 parts | KF353 | 0.2 parts | LiTFSI | 0.15 parts | 0.5 parts |
| Example 7 | 100 parts | C/HX | 3.5 parts | HDI | 0.3 parts | KF353 | 0.2 parts | LiTFSI | 0.15 parts | 0.5 parts |
| Example 8 | 100 parts | C/HX | 3.5 parts | TAKENATE 600 | 0.3 parts | KF353 | 0.2 parts | LiTFSI | 0.15 parts | — |
| Comparative | 100 parts | C/HX | 3.5 parts | — | — | KF353 | 0.2 parts | LiTFSI | 0.15 parts | — |
| Example 1 | | | | | | | | | | |
| Comparative | 100 parts | C/HX | 4 parts | — | — | KF353 | 0.2 parts | LiTFSI | 0.15 parts | — |
| Example 2 | | | | | | | | | | |
| Comparative | 100 parts | C/HX | 5.2 parts | — | — | KF353 | 0.2 parts | LiTFSI | 0.15 parts | — |
| Example 3 | | | | | | | | | | |
| Comparative | 100 parts | C/HX | 3.5 parts | — | — | KF353 | 0.2 parts | LiTFSI | 0.15 parts | 0.5 parts |
| Example 4 | | | | | | | | | | |
| Comparative | 100 parts | C/HX | 3.5 parts | — | — | KF353 | 0.2 parts | LiTFSI | 0.15 parts | — |
| Example 5 | | | | | | | | | | |
| Comparative | 100 parts | C/HX | 1.75 parts | TAKENATE 600 | 1 part | — | — | — | — | — |
| Example 6 | | | | | | | | | | |

TABLE 4

| | | Crosslinking agent | | | | | | | | |
|---|---|---|---|---|---|---|---|---|---|---|
| Pressure- | | Tri-functional | | | | Silicone | | | | |
| sensitive | | NCO | | Bi-functional NCO | | component | | Antistatic agent | | Oligomer |
| adhesive | | | Addition | | Addition | | Addition | | Addition | Addition |
| composition | Polymer | Type | amount | Type | amount | Type | amount | Type | amount | amount |
| Example 9 | 100 parts | C/HX | 3.5 parts | TAKENATE 600 | 0.3 parts | KF353 | 0.2 parts | BMPTFSI | 0.15 parts | — |
| Example 10 | 100 parts | C/HX | 3.5 parts | TAKENATE 600 | 0.3 parts | KF353 | 0.2 parts | BMPTFS | 0.15 parts | — |
| Example 11 | 100 parts | C/HX | 3.5 parts | TAKENATE 600 | 0.3 parts | KF353 | 0.2 parts | EMITFS | 0.15 parts | — |
| Example 12 | 100 parts | C/HX | 3.5 parts | TAKENATE 600 | 0.3 parts | KF353 | 0.2 parts | EMITFSI | 0.15 parts | — |
| Example 13 | 100 parts | C/HX | 3.5 parts | TAKENATE 600 | 0.3 parts | KF353 | 0.2 parts | EMIFSI | 0.15 parts | — |
| Example 14 | 100 parts | C/HX | 3.5 parts | TAKENATE 600 | 0.3 parts | KF353 | 0.2 parts | LiTFS | 0.15 parts | — |
| Example 15 | 100 parts | C/HX | 3.5 parts | TAKENATE 600 | 0.3 parts | KF353 | 0.2 parts | MPPyTFSI | 0.15 parts | — |
| Example 16 | 100 parts | C/HX | 3.5 parts | TAKENATE 600 | 0.3 parts | KF353 | 0.2 parts | MPPyFSI | 0.15 parts | — |
| Example 17 | 100 parts | C/HX | 3.5 parts | TAKENATE 600 | 0.3 parts | KF353 | 0.2 parts | MPPiTFSI | 0.15 parts | — |
| Example 18 | 100 parts | C/HX | 3.5 parts | TAKENATE 600 | 0.3 parts | KF353 | 0.2 parts | MPPiFSI | 0.15 parts | — |
| Example 19 | 100 parts | C/HX | 3.5 parts | TAKENATE 600 | 0.3 parts | KF353 | 0.2 parts | BMITFSI | 0.15 parts | — |
| Example 20 | 100 parts | C/HX | 3.5 parts | TAKENATE 600 | 0.3 parts | KF353 | 0.2 parts | ACTFSI | 0.15 parts | — |
| Example 21 | 100 parts | C/HX | 3.5 parts | TAKENATE 600 | 0.3 parts | KF6004 | 0.2 parts | LiTFSI | 0.15 parts | — |
| Example 22 | 100 parts | C/L | 2.5 parts | TAKENATE 600 | 0.3 parts | KF353 | 0.2 parts | LiTFSI | 0.15 parts | — |

The abbreviations in Table 3 and Table 4 will be described below.

Tri-functional NCO: tri-functional isocyanate compound (crosslinking agent)

Bi-functional NCO: bi-functional isocyanate compound (crosslinking agent)

C/HX: tri-functional isocyanate compound (crosslinking agent): isocyanurate of hexamethylene diisocyanate (trade name: CORONATE HX, manufactured by Nippon Polyurethane Industry Co., Ltd.) (effective component 100%)

C/L: tri-functional isocyanate compound (crosslinking agent): trimethylolpropane/tolylene diisocyanate (trade name: CORONATE L, manufactured by Nippon Polyurethane Industry Co., Ltd.) (effective component 100%)

TAKENATE 500: bi-functional isocyanate compound (crosslinking agent):1,3-bis(isocyanatomethyl)benzene(trade name: TAKENATE 500, manufactured by Mitsui Chemicals, Inc.) (effective component 100%)

TAKENATE 600: bi-functional isocyanate compound (crosslinking agent): 1,3-bis(isocyanatomethyl)cyclohexane (trade name: TAKENATE 600, manufactured by Mitsui Chemicals, Inc.) (effective component 100%)

HDI: bi-functional isocyanate compound (crosslinking agent): hexamethylene diisocyanate (trade name: HDI, manufactured by Nippon Polyurethane Industry Co., Ltd.) (effective component 100%)

KF 353: organopolysiloxane having oxyalkylene chains (HLB value: 10; trade name: KF-353, manufactured by Shin-Etsu Chemical Co., Ltd.) (effective component 100%) (silicone component)

KF 6004: organopolysiloxane having oxyalkylene chains (HLB value: 9; trade name: KF-6004, manufactured by Shin-Etsu Chemical Co., Ltd.) (effective component 100%) (silicone component)

LiTFSI: alkali metal salt: lithium bis(trifluoromethanesulfonyl)imide (LiN(CF₃SO₂)₂, manufactured by Tokyo Kasei Kogyo Co., Ltd.) (effective component 100%) (antistatic agent)

BMPTFSI: ionic liquid: 1-butyl-3-methylpyridinium bis(trifluoromethanesulfonyl)imide, manufactured by Japan Carlit Co., Ltd. (effective component 100%) (antistatic agent)

BMPTFS: ionic liquid: 1-butyl-3-methylpyridinium trifluoromethanesulfonic acid, manufactured by Japan Carlit Co., Ltd. (effective component 100%) (antistatic agent)

EMITFS: ionic liquid: 1-ethyl-3-methylimidazolium trifluoromethanesulfonic acid, manufactured by Tokyo Kasei Kogyo Co., Ltd. (effective component 100%) (antistatic agent)

EMITFSI: ionic liquid: 1-ethyl-3-methylimidazolium bis(trifluoromethanesulfonyl)imide, manufactured by Tokyo Kasei Kogyo Co., Ltd. (effective component 100%) (antistatic agent)

EMIFSI: ionic liquid: 1-ethyl-3-methylimidazolium bis(fluorosulfonyl)imide, manufactured by Dai-Ichi Kogyo Seiyaku Co., Ltd. (effective component 100%) (antistatic agent)

LITFS: alkali metal salt: lithium trifluoromethanesulfonic acid, manufactured by Tokyo Kasei Kogyo Co., Ltd. (effective component 100%) (antistatic agent)

MPPyTFSI: ionic liquid: 1-methyl-1-propylpyrrolidinium bis(trifluoromethanesulfonyl)imide, manufactured by Dai-Ichi Kogyo Seiyaku Co., Ltd. (effective component 100%) (antistatic agent)

MPPyFSI: ionic liquid: 1-methyl-1-propylpyrrolidinium bis(fluorosulfonyl)imide, manufactured by Dai-Ichi Kogyo Seiyaku Co., Ltd. (effective component 100%) (antistatic agent)

MPPITFSI: ionic liquid: 1-methyl-1-propylpiperidinium bis(trifluoromethanesulfonyl)imide, manufactured by Dai-Ichi Kogyo Seiyaku Co., Ltd. (effective component 100%) (antistatic agent)

MPPIFSI: ionic liquid: 1-methyl-1-propylpiperidinium bis(fluorosulfonyl)imide, manufactured by Dai-Ichi Kogyo Seiyaku Co., Ltd. (effective component 100%) (antistatic agent)

BMIMTFSI: ionic liquid: 1-butyl-3-methylimidazolium bis(trifluoromethanesulfonyl)imide, manufactured by Tokyo Kasei Kogyo Co., Ltd. (effective component 100%) (antistatic agent)

ACTFSI: ionic liquid: acetylcholine bis(trifluoromethanesulfonyl)imide, manufactured by Rhodia Japan Co., Ltd. (effective component 100%) (antistatic agent)

Oligomer: acrylic oligomer (weight average molecular weight: 4000, glass transition temperature (Tg): 144° C.)

TABLE 5

| | Low-speed adhesive strength to | | | |
|---|---|---|---|---|
| | acrylic film (resin) [N/25 mm] | | | |
| | Adhesive | Adhesive | Adhesive | Peeling |
| | strength (A) | strength (B) | strength | electrification |
| Evaluation | in initial period | after heating | ratio | voltage to acrylic |
| results | (23° C. × 30 min) | (60° C. × one week) | (B/A) | film [kV] |
| Example 1 | 0.02 | 0.03 | 1.5 | 0 |
| Example 2 | 0.02 | 0.03 | 1.5 | 0 |
| Example 3 | 0.02 | 0.02 | 1.0 | 0 |
| Example 4 | 0.02 | 0.02 | 1.0 | 0 |
| Example 5 | 0.02 | 0.04 | 2.0 | 0 |
| Example 6 | 0.02 | 0.05 | 2.5 | 0 |
| Example 7 | 0.02 | 0.05 | 2.5 | 0 |
| Example 8 | 0.02 | 0.02 | 1.0 | 0 |
| Comparative | 0.02 | 0.07 | 3.5 | 0 |
| Example 1 | | | | |
| Comparative | 0.02 | 0.06 | 3.0 | 0 |
| Example 2 | | | | |
| Comparative | 0.02 | 0.06 | 3.0 | 0 |
| Example 3 | | | | |
| Comparative | 0.03 | 0.09 | 3.0 | 0 |
| Example 4 | | | | |
| Comparative | 0.02 | 0.06 | 3.0 | 0 |
| Example 5 | | | | |
| Comparative | 0.14 | 0.15 | 1.1 | 2.1 |
| Example 6 | | | | |

TABLE 6

| | Low-speed adhesive strength to | | | |
|---|---|---|---|---|
| | acrylic film (resin) [N/25 mm] | | | |
| | Adhesive | Adhesive | Adhesive | Peeling |
| | strength (A) | strength (B) | strength | electrification |
| Evaluation | in initial period | after heating | ratio | voltage to for acrylic |
| results | (23° C. × 30 min) | (60° C. × one week) | (B/A) | film [kV] |
| Example 9 | 0.02 | 0.04 | 2.0 | 0 |
| Example 10 | 0.02 | 0.05 | 2.5 | 0 |
| Example 11 | 0.02 | 0.02 | 1.0 | 0 |
| Example 12 | 0.02 | 0.04 | 2.0 | 0 |
| Example 13 | 0.02 | 0.05 | 2.5 | 0 |
| Example 14 | 0.04 | 0.04 | 1.0 | 0 |
| Example 15 | 0.02 | 0.04 | 2.0 | 0.3 |
| Example 16 | 0.02 | 0.05 | 2.5 | 0.2 |
| Example 17 | 0.02 | 0.04 | 2.0 | 0.4 |
| Example 18 | 0.02 | 0.05 | 2.5 | 0.3 |
| Example 19 | 0.03 | 0.04 | 1.3 | 0 |
| Example 20 | 0.02 | 0.05 | 2.5 | 0 |
| Example 21 | 0.02 | 0.04 | 2.0 | 0.2 |
| Example 22 | 0.04 | 0.06 | 1.5 | 0.4 |

According to the results in Table 5 and Table 6, in all of Examples, it was found that the adhesive properties, the removability, the workability following these properties, and the antistatic properties are excellent. The surface protective films obtained in Examples were found usable for the purpose of protecting a surface of an optical member or the like.

On the other hand, in Comparative Examples 1 to 5, since only a tri-functional isocyanate compound (crosslinking agent) was used as a crosslinking agent, an increase in adhesive strength ratio was found. The reason for this is presumed to be that only a tri-functional isocyanate compound is added without no addition of bi-functional isocyanate compound, and thus a crosslinking structure becomes sparse; that is, no highly advanced crosslinking structure is formed and it results in an increase in adhesive strength. In Comparative Example 6, no silicone component was added nor was transferred to the surface of the acrylic film, which was an adherend, and thus it was presumed to be that an increase in adhesive strength was caused, and further, no antistatic agent was added, and as a result, the antistatic properties were also deteriorated.

### DESCRIPTION OF REFERENCE SIGNS

1 Surface protective film (Pressure-sensitive adhesive sheet)
2 Acrylic film
3 Sample mount
4 Potential meter

1. A pressure-sensitive adhesive composition for acrylic film protection comprising a (meth)acrylic polymer containing a (meth)acrylic monomer having an alkyl group of 1 to 14 carbon atoms in a proportion of 50 to 99.9 wt % as a monomer component, a tri-functional isocyanate crosslinking agent, a di-functional isocyanate crosslinking agent, an organopolysiloxane having oxyalkylene chains, and an ionic compound.

2. The pressure-sensitive adhesive composition for acrylic film protection according to claim 1, wherein the (meth)acrylic polymer contains a hydroxyl group-containing (meth)acrylic monomer as a monomer component.

3. The pressure-sensitive adhesive composition for acrylic film protection according to claim 1, wherein the ionic compound is an alkali metal salt and/or an ionic liquid.

4. The pressure-sensitive adhesive composition for acrylic film protection according to claim 1, which comprises an acrylic oligomer.

5. A surface protective film for acrylic film protection having a support film and a pressure-sensitive adhesive layer formed by crosslinking the pressure-sensitive adhesive composition according to claim 1 on at least one surface of the support film.

6. The surface protective film for acrylic film protection according to claim 5, which has an adhesive strength ratio (B/A) of the adhesive strength (A) at a peel rate of 0.3 m/min after the pressure-sensitive adhesive surface of a pressure-sensitive adhesive layer formed by crosslinking the pressure-sensitive adhesive composition is attached to an acrylic film at 23° C. for 30 minutes and the adhesive strength (B) at a peel rate of 0.3 m/min after the pressure-sensitive adhesive surface of a pressure-sensitive adhesive layer formed by crosslinking the pressure-sensitive adhesive composition is attached to an acrylic film at 60° C. for one week of 2.8 or lower.

7. An optical member, which is protected by the surface protective film for acrylic film protection according to claim 5.

8. A surface protective film for acrylic film protection having a support film and a pressure-sensitive adhesive layer formed by crosslinking the pressure-sensitive adhesive composition according to claim 2 on at least one surface of the support film.

9. A surface protective film for acrylic film protection having a support film and a pressure-sensitive adhesive layer formed by crosslinking the pressure-sensitive adhesive composition according to claim 3 on at least one surface of the support film.

10. A surface protective film for acrylic film protection having a support film and a pressure-sensitive adhesive layer formed by crosslinking the pressure-sensitive adhesive composition according to claim 4 on at least one surface of the support film.
